(19) United States
(12) Patent Application Publication
(10) Pub. No.: US 2024/0319062 A1
(43) Pub. Date: Sep. 26, 2024

(54) SUSPENDED PARTICLE CONCENTRATION, DETECTION, AND ANALYSIS

(71) Applicant: Regents of the University of Minnesota, Minneapolis, MN (US)

(72) Inventors: Francisco J Romay, Vadnais Heights, MN (US); Yan Ye, Saratoga, CA (US); David Y.H. Pui, Medina, MN (US)

(21) Appl. No.: 18/587,203

(22) Filed: Feb. 26, 2024

Related U.S. Application Data
(60) Provisional application No. 63/448,573, filed on Feb. 27, 2023.
(60) Provisional application No. 63/597,607, filed on Nov. 9, 2023.

(51) Int. Cl. G01N 15/0227; G01N 1/22; G01N 1/40; G01N 15/00; G01N 15/1434

(52) U.S. Cl. CPC G01N 15/0227; G01N 1/2202; G01N 1/2208; G01N 1/40; G01N 15/00; G01N 15/1436; G01N 2001/2223; G01N 2015/0046

(57) ABSTRACT

A method of suspended particle detection includes receiving, with a particle concentrator, an aerosol comprising particles suspended within a bulk gas. The aerosol has a first concentration indicative of count of particles per unit volume of the bulk gas. The method includes concentrating, with the particle concentrator, the aerosol to generate a particle-rich stream of gas comprising at least one particle. The particle-rich stream of gas has a second concentration greater than the first concentration. The method includes irradiating the at least one particle in the particle-rich stream of gas with a light source of a certain wavelength in a detection chamber, and capturing image data relating to the at least one particle with an image sensor located within the detection chamber.

This application claims the benefit of U.S. Provisional Patent Application No. 63/597,607, filed Nov. 9, 2023 and U.S. Provisional Application No. 63/448,573, filed Feb. 27, 2023, the entire contents of each application is incorporated herein by reference.

### GOVERNMENT RIGHTS

This invention was made with government support under W9124P-23-P-0024 awarded by the Army Research Lab. The government has certain rights in the invention.

### BACKGROUND

Detection of suspended particles, such as airborne particles, may be important due to the impact of suspended particles on a range of issues, from air pollution to disease transmission. Suspended particles may cause different adverse effects due to their relatively high specific surface area. Airborne nanoparticles can easily spread over a large area for extended periods and can easily enter and transfer within organisms and interact with cells and subcellular components. Detection of suspended particles may be an important step in treating gases which contain suspended particles, or evaluating systems or equipment designed to remove suspended particles. Detection and analysis of suspended particles may be important even when the airborne particles are present at extremely low concentrations.

### SUMMARY

In general, the disclosure is directed to systems and techniques for detecting and analyzing particles suspended within a gas, such as air. A colloidal suspension of particles, whether solid or liquid, in air may be called an aerosol. In some examples, the concentration of airborne particles or airborne particles of interest (e.g., biological particles) may be so low that proper sampling is difficult and/or time consuming. As described in more detail, the disclosed systems and techniques may use one or more particle concentrators to concentrate (e.g., increase the particle count per unit volume) an aerosol for analysis. In some examples, the particle concentrator may be configured to preferentially separate particles of interest, thereby increasing their concentration. The particles of interest may, in some examples, be particles that fall within a certain particle size range. The particle concentrator may receive the raw or unconcentrated aerosol as a bulk gas and output a particle-rich stream of gas (i.e., a concentrated aerosol) to a particle detection and analysis unit. The particle detection and analysis unit may be separate from or integral with the particle concentrator. The particle detection and analysis unit may perform image processing to detect, analyze, quantify, and/or categorize suspended particles in the particle-rich stream of gas. Thus, by concentration of particles of interest within an aerosol, the disclosed systems and techniques may detect and characterize particles such as biological particles present in the aerosol at low (e.g., less than about 1,000 particles per liter (particles/L) or extremely low (e.g., less than about 1 particles/L) concentration, which may be beyond the capability of other particle detection techniques. “About,” as used herein, may comprise the stated value and those values with a range of 10%, or 20%, or 30% of the stated value.

Furthermore, by concentrating particles present in the particle-rich stream of gas at a known ratio relative to the aerosol, the disclosed systems and techniques may more accurately and/or quickly detect, count, and/or analyze particles within the aerosol, whether the system is sampling an aerosol contained within a duct or open to the ambient conditions in a building or outdoors. Additionally, because the disclosed systems may include a particle concentrator and particle detection unit packaged together or as discrete modules, the disclosed systems may be portable and/or lightweight enough to be deployed in more applications than conventional stationary particle detection and analysis systems.

The disclosed systems and techniques may employ a particle detection and analysis unit to categorize target particle types, such as bioaerosols including bacteria, viruses, fungi, or the like. The particle concentrator may advantageously be configured to preferentially separate particles within a certain particle size range into the particle-rich stream for analysis. For example, because many biological particles define a maximum dimension that is greater than about 1 micrometer, whether by themselves or when combined with other particles present in the air, the particle concentrator may be configured to preferentially separate (e.g., by an inertia-based mechanism) a majority of particles above a particle size cutoff point (e.g., of 1 micrometer) into the particle-rich stream for analysis.

In this way, a majority of the particles of interest may be concentrated into a particle-rich stream via a particle concentrator for detection and analysis by a particle detection and analysis unit. The particle detection and analysis unit may then capture an image of at least one particle in the particle-rich stream of gas when the particle rich stream is routed into a detection chamber.

In some examples, the disclosed system may be configured to irradiate the at least one particle using a light source. An image sensor may detect images generated by elastic scattered light and the induced fluorescence when light from the light source contacts the particle or particles. The system may include processing circuitry configured to store image data from one or more image sensors in a detection video. The captured images of induced fluorescence in the detection video may be converted to quantitative information about one or more particles. The quantitative data may include one or more of a particle count, particle concentration, image size distribution, or wavelength distribution of induced fluorescence.

In some examples, the disclosure is directed to techniques for suspended particle detection. The technique may include receiving, with a particle concentrator, an aerosol comprising particles suspended within a bulk gas. The aerosol may have a first concentration indicative of count of particles per unit volume of the bulk gas. The technique further includes concentrating, with the particle concentrator, the aerosol to generate a particle-rich stream of gas comprising at least one particle. The particle-rich stream of gas having a second concentration greater than the first concentration. The technique also includes irradiating the at least one particle in the particle-rich stream of gas with a light source of a certain wavelength in a detection chamber. The technique also includes capturing image data relating to the at least one particle with an image sensor located within the detection chamber.

In some examples, the disclosure is directed to a system which includes a particle concentrator and a particle detection and analysis unit. The particle detection unit may include at least one light source of a certain wavelength configured to irradiate at least one particle, at least one image sensor or camera configured to capture image relating to the at least one particle and one or more processors. The one or more processors may be configured to obtain a frame of grayscale image data comprising luminance values of image data captured by the image sensor or camera and analyze the image data in the frame to identify at least one particle captured in the frame. To analyze the image data, the one or more processors are configured to identify pixels having luminance values that satisfy a threshold, determine particle contours of the at least one particle based on the identified pixels, and generate at least one of quantitative or qualitative information for the at least one particle based at least partially on the analyzing of the image data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic view illustrating an example suspended particle detection system according to the present disclosure.

FIG. 2 is a schematic view illustrating an example suspended particle detection system according to one or more examples of the present disclosure.

FIG. 3 is a schematic cross-sectional view illustrating a portion of a concentrating virtual impactor (CVI) type particle concentrator according to one or more examples of the present disclosure.

FIG. 4 is a schematic perspective view of an example particle concentrator according to the present disclosure.

FIGS. 5 and 6 are schematic cross-sectional views illustrating example stages of a particle concentrator according to the present disclosure.

FIG. 7 is a block diagram illustrating of an example computing device according to the present disclosure.

FIG. 8 is a flowchart illustrating an example particle detection and analysis technique in accordance with one or more aspects of the present disclosure.

FIG. 9 is a flowchart illustrating an example particle detection and analysis technique in accordance with one or more aspects of the present disclosure.

FIG. 10 is a flowchart illustrating an example real-time particle detection and analysis technique in accordance with one or more aspects of the present disclosure.

FIG. 11 is a flowchart illustrating an example technique for converting sensed image data to quantitative and/or qualitative information about at least one particle.

FIGS. 12A, 12B, 12C, and 12D are schematic illustrations of various representations of an example particle.

FIG. 13 is a set of pictures illustrating the results of particle detection and image processing techniques in accordance with one or more aspects of the present disclosure.

FIG. 14 illustrates example reactions from a particle under irradiation by a light source.

FIG. 15 is a table illustrating example particle information which may be stored in a memory in accordance with one or more aspects of the present disclosure.

FIG. 16 illustrates an example chromaticity diagram for determining a color hue used to calculate a dominant wavelength in accordance with one or more aspects of the present disclosure.

FIG. 17 illustrates an example color image in accordance with one or more aspects of the present disclosure.

FIG. 18 is a schematic diagram illustrating a portion of an example system in accordance with one or more aspects of the present disclosure.

FIGS. 19A and 19B illustrate example systems for sampling in accordance with one or more aspects of the present disclosure.

FIGS. 20A and 20B illustrate additional example systems for sampling in accordance with one or more aspects of the present disclosure.

FIG. 21 illustrates example screenshots from an example display in accordance with one or more aspects of the present disclosure.

FIG. 22 illustrates an example screenshot from a display according to the present disclosure.

FIG. 23 illustrates example results from particle recognition tests using techniques according to the present disclosure.

FIG. 24 illustrates example screenshots from an example display according to the present disclosure.

FIG. 25 illustrates example screenshots from an example display according to the present disclosure.

FIG. 26 illustrates example screenshots from an example display according to the present disclosure.

### DETAILED DESCRIPTION

Detecting particles suspended in the air using optical detection techniques may be challenging compared to detecting particles suspended in liquids such as in water. Furthermore, in some examples, particles of particular interest in the gas may be difficult to detect at low or extremely low concentration. Such particles of interest may be biological particles such as viruses or the like. Example cases where such particles may be present are in clean processes, although other scenarios where detection of particles at low (e.g., less than about 1,000 particles/L or extremely low (e.g., less than about 1 particle/L) concentration are considered.

For example, in the natural environment, whether outdoors or in an enclosed environment the fraction of particles of biological origin may be small because other natural or man-made particles may be present in much larger numbers, such as dust particles or the like. Therefore, in some applications it may be necessary to concentrate or increase the concentration of the particles of interest by several orders of magnitude before the particles can be counted, measured, categorized, and/or analyzed. Systems and techniques according to the present disclosure combine a particle concentrator with a light-based particle detection and analysis unit which may detect the induced fluorescence or enhanced light scattering signals from the particles of interest. In this way, particles of interest may be quickly and accurately measured and analyzed relative to other particle detection systems and techniques. Furthermore, systems according to the present disclosure which include a particle concentrator and a particle sensing device, which may also be called a detection and analysis unit, may be relatively easy to make, additively manufactured, portable, low-power, and/or lightweight relative to other systems.

Systems according to the present disclosure may include a particle detection and analysis unit which senses and analyzes a particle in a particle-rich stream output by a particle concentrator. Although the aerosol may contain a low or extremely low concentration of particles of interest, the particle concentrator may increase the concentration of particles of interest and output the particle-rich stream of gas for analysis by the particle detection and analysis unit. In some examples, the particle concentrator may be a concentrating virtual impactor (CVI) device that performs an inertia-based preferential particle separation into a particle-rich stream of gas and a particle-lean stream of gas.

With respect to the detection and analysis of the particle-rich gas stream, a light-based image processing technique may be employed. Particles in a suspending media can be detected by measuring fluctuations in the intensity of light scattered from moving particles, as in dynamic light scattering (DLS) measurement. This is because when particles move randomly in Brownian motion (motion caused by diffusion only), the diffusivity of suspended particles can be deduced from the autocorrelation function describing the fluctuation signals. For particles suspended in a liquid, it may be easy to maintain the motion of particles as Brownian motion, especially when the liquid is confined in a small container or in a stationary droplet. For particles suspended in the air, the detection is still challenging. It may not be practical in some instances to confine air samples in small spaces or small containers or to control the motion of the airborne particles so that the motion is caused only by their diffusion. Since airborne nanoparticles are more mobile and more prone to uncontrolled non-Brownian motion than nanoparticles suspended in liquids, techniques that can successfully detect nanoparticles in liquids, such as DLS or advanced optic microscopes, are rarely used for detecting or analyzing airborne nanoparticles.

Systems and techniques according to the present disclosure may be suitable for particle detection of particles suspended in air or another gas. For instance, techniques described in this disclosure may successfully detect and analyze airborne particles. Particles may be irradiated with a light source in a detection chamber, and an imager (e.g., a color image sensor or camera) may capture image data indicative of the detection chamber at a particular point in time. The image data may be image processed (e.g., in real-time or at a later time) to capture quantitative data and/or qualitative data about at least one particle within the detection chamber. For example, quantitative data may include one or more of a particle count, particle concentration, or particle size. The particle-rich stream of gas may then be output by the particle detection and analysis unit.

Furthermore, the disclosed systems and techniques may be used to detect bioparticles suspended in a gas. Bioparticles (“bioaerosols,” when suspended in air), may be particles that include biological material. Bioaerosols may be detected by the disclosed systems and techniques because irradiation of suspended particles with light of a certain known wavelength may induce fluorescence in some types of particles and not induce fluorescence in other types of particles. For example, excitation of some wavelengths of light may induce fluorescence in bioparticles and not induce fluorescence in abiotic particles, which do not include biological material.

The disclosed system may include a light source configured to emit light at wavelengths which induce fluorescence in bioparticles and not induce fluorescence in abiotic particles. The imager may be configured to detect the induced fluorescence by filtering at least a portion of the sensed image data so that only induced fluorescence is detected. In some examples, a single imager may be used, and a portion of the image data may be filtered such that a portion of the captured image data may be filtered to capture the induced fluorescence of at least one particle. Alternatively, in some examples, a second imager may be included, and one imager may be configured to capture clastic scattered light scattered by the particle, where particles scatter light according to their size as demonstrated by the principles of Rayleigh scattering. As such, the second imager may include a filter configured to capture only induced fluorescence of the particle or particles in the detection chamber. The dominant color hue of the induced fluorescence may be used to calculate a dominant wavelength of the particle. Since the wavelength (e.g., the dominant wavelength) of certain particles is known, this wavelength may be used in categorize the detected particle or particles into, for example, bioparticles and abiotic particles, or between different categories of bioparticles. The emitted wavelength of a particle in the detection chamber may be compared to a database of known particles in a database, and a match may allow for a particular particle species to be recognized.

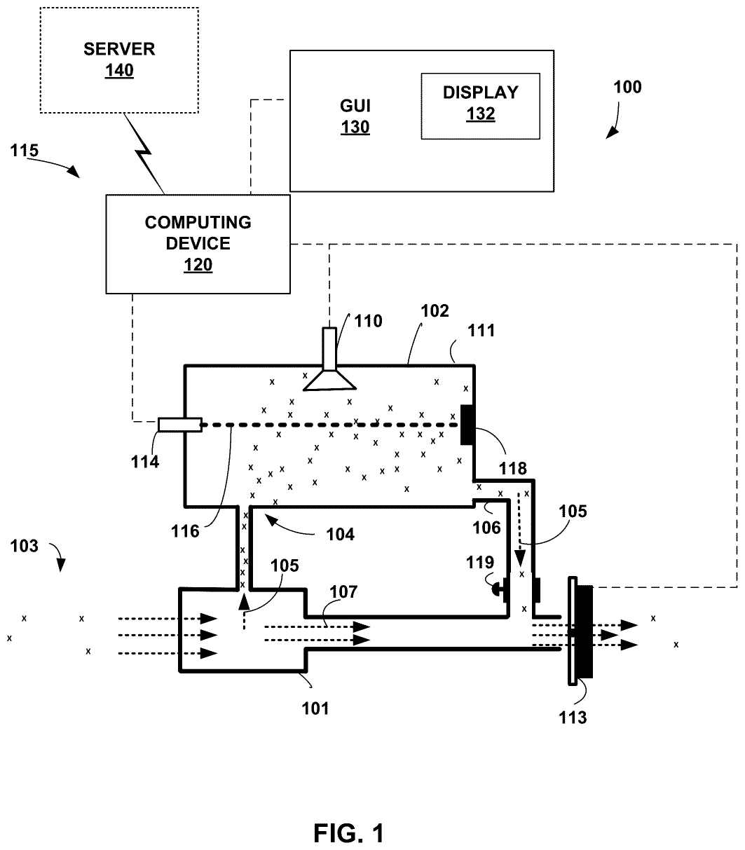

FIG. 1 is a schematic perspective view of example system 100 for concentrating, detecting, and image processing suspended particles in aerosol 103, according to one or more aspects of this disclosure. System 100 includes particle concentrator 101 and particle detection and analysis unit 111. Particle detection and analysis unit 111 includes detection chamber 102, imager 110, light source 114, and workstation 115. Workstation 115 includes computing device 120, graphical user interface (GUI) 130, and server 140. System 100 may be an example of a system for use in a particle detection laboratory, a cleanroom, a building, a moving vehicle, or other application.

Aerosol 103 may define a first concentration of particles. Individual particles are indicated by “x” in FIG. 1, in a bulk gas, which may be air. Although illustrated as an uncontained environment in FIG. 1, aerosol 103 may be enclosed in an enclosure such as a duct or pipe in some examples. The concentration of particles may be a measurement of the count of particles per unit volume of the bulk gas. As such, the concentration may be measured in particle count per liter, or similar measurement.

Particle concentrator 101 may be a concentrating virtual impactor (CVI) device that performs an inertia-based preferential particle separation of aerosol 103 and output particle-rich stream of gas 105 and particle-lean stream of gas 107. Particle-rich stream of gas 105 may also be called the minor flow stream because particle-rich stream of gas 105 may have a lower volumetric flow rate than particle-lean stream of gas 107, which may be called the major flow stream. As illustrated, particle concentrator 101 may preferentially separate particles (or, a portion of the particles within a certain size range or above a particle cut-off point) such that particle-rich minor flow stream 105 contains a majority of the particles larger than the cutoff size in aerosol 103 and only a small portion of the bulk gas. Accordingly, particle-lean major flow stream may contain a majority of the bulk gas in aerosol 103, but only a minority of the particles that are larger than the particle size cutoff point that were originally in aerosol 103.

In some examples, particle concentrator 101 is configured to concentrate aerosol 103 by preferentially separating particles by the particle's inertia into one of particle-lean stream 107 or particle-rich stream of gas 105. In some examples, inertial separation may include causing a majority of particles in aerosol 103 which have a maximum dimension that is above a particle size cut point in the aerosol to enter the particle-rich minor stream of gas 105, and causing a majority of particles which have a maximum dimension that is below the particle size cut point in aerosol 103 to enter the particle-lean major stream of gas 107. Furthermore, although not illustrated in FIG. 1, in some examples, particle concentrator 101 may first-pass pre-separator to remove a majority of particles which have a maximum dimension above a second particle size cut point. In such example, the first-pass pre-separator may be an initial stage which concentrates large particles (e.g., with a maximum dimension of above 10 micrometers) in a particle-rich minor flow stream which is discarded to the environment, and passes a major flow stream on to be further concentrated. In this way, upper and lower particle size cut points may be set at different stages of particle concentrator 101, and aerosol 103 may be concentrated in series at each stage until the desired size range and flow rate is prepared for output to detection chamber 102.

In some examples, system 100 may include one or more optional blowers 113 as a separate component or integral with particle concentrator 101. In some examples, blower 113 may be a fan configured to cause particle concentrator 101 to receive aerosol 103 and output particle-rich stream 105 from a first outlet and particle-lean stream 107 from a second outlet. In some examples, blower 113 according to the present disclosure may advantageously be run without needing a high-power supply. For example, blower 113 may be provided with power from about 10 watts to about 300 watts, such as less than about 100 watts. The power supplied to blower 113, along with other design considerations, may impact the way particle concentrator 101 preferentially separates particles by inertia. As such, the power supply may be selectively tailored to drive the blower with a relatively low pressure drop (e.g., about 2.5 kPa) across particle concentrator 101. Furthermore, the smaller size of the system 100 may also allow for inclusion of system 100 in applications where compact, portable, and/or lightweight systems are required, such as within a vehicle, boat, or aircraft, etc.

In some examples, a ratio of a volumetric flow rate of the particle-lean stream of gas to a volumetric flow rate of the particle-rich stream of gas is in a range of from about 10:1 to about 1000:1. In some examples, the concentration ratio between particle-rich stream of gas 105 and aerosol 103 is in a range of from about 10 to about 1000. Put differently, particle-rich stream 105 may contain at least about 10 times more particles per unit volume than aerosol 103. As such, particle-rich stream of gas 105 may be output into detection chamber 102 of particle detection and analysis unit 111 at a flow rate and concentration where detection and analysis of the particles may be performed. In systems that do not include particle concentrator 101, detection and analysis of particles in aerosol 103 may be difficult or impossible because the low or extremely low concentration of the particles would cause the analysis to be time-inefficient. Furthermore, since particles of interest are preferentially sorted into particle-rich stream 105 by particle concentrator 101, image capture and image processing of these particles may be performed with reduced interference from undesired particles such as dust particles which are below a particle size cut point.

Particle-rich flow stream 105 may be output into detection chamber 102 of particle detection and analysis unit 111. In some examples, as illustrated, particle concentrator 101 may be a separate component fluidically connected to detection chamber 102 by a pipe or tube. Detection chamber 102 may be a chamber configured to receive a particle-rich minor stream of gas 105 (e.g., air) containing a majority of suspended particles larger than a cutoff size of particle concentrator 101 from aerosol 103. The particles may be excited and/or irradiated by light source 114 in detection chamber 102. Image detection by imager 110 may be performed before outputting the stream of gas 105 into the surroundings. As such, detection chamber 102 may include one or more inlets 104 and one or more outlets 106. Blower 113 may be configured to input energy into one or more of aerosol 103, particle-rich stream of gas 105, and/or particle-lean stream of fluid 107 to move aerosol 103 through system 100. In the illustrated example, blower 113 pulls both particle-lean stream of gas 107 through particle concentrator 101 and particle-rich stream of gas 105 through particle concentrator 101 and detection chamber 102. In other examples, blower 113 may include a first blower to draw particle-lean stream of fluid 107 through particle concentrator 101 and a second small blower or suction device may draw particle-rich stream of gas 105 into detection chamber 102 and out through outlet 106. In some examples, inlet 104, outlet 106, and/or particle concentrator 101 may include one or more valves 119 or other flow regulation mechanisms.

Light source 114 may be configured to emit a beam of light 116 into detection chamber 102, and imager 110 may be configured to capture image data within detection chamber 102. In some examples, detection chamber 102 may be configured to control light within detection chamber 102, such as by allowing light source 114 to irradiate particles and blocking out other light. Therefore, detection chamber 102 may include walls or a lining which create a dark background by completely or nearly completely occluding ambient light from outside detection chamber 102, for example by reducing or eliminating light from entering detection chamber 102.

Workstation 115 may include, for example, an off-the-shelf device, such as a laptop computer, desktop computer, tablet computer, smart phone, or other similar device. In some examples, workstation 115 may be a specific purpose device. Workstation 115 may be configured to control blower 113 and/or any associated valves, imager 110, light source 114, or any other accessories and peripheral devices relating to, or forming part of, system 100.

Computing device 120 may include, for example, an off-the-shelf device such as a laptop computer, desktop computer, tablet computer, smart phone, or other similar device or may include a specific purpose device. In some examples, computing device 120 control blower 113 and/or any associated valves, imager 110, light source 114, or any other accessories and peripheral devices relating to, or forming part of, system 100 and may interact extensively with workstation 115. Workstation 115 may be communicatively coupled to computing device 120, enabling workstation 115 to control the operation of imager 110 and receive the output of imager 110.

Graphical user interface (GUI) 130 may be configured to output instructions, images, and messages relating to at least one of a performance, position, viewing angle, image data, or the like from imager 110, light source 114, and or pump 108. GUI may include display 132. Display 132 may be configured to display outputs from any of the components of system 100, such as computing device 120. Further, GUI 130 may be configured to output information regarding imager 110, e.g., model number, type, size, etc. on display 132. Further, GUI 130 may be configured to output sample information regarding sampling time, location, volume, flow rate, concentration ratio, volumetric flow rate of minor stream 105 and/or major stream 107, or the like. GUI 130 may be configured to present options to a user that include step-by step, on screen instructions for one or more operations of system 100. For example, GUI 130 may present an option to a user to select a file of sensed image data from imager 110 at a particular point in time or a duration in time as video image data. GUI 130 may allow a user to click rather than type to select, for examples, an image data file from imager 110 for analysis, a technique selection for system 100, a mode of operation of system 130, various settings of operation of system 130 (e.g., an intensity or wavelength of light from light source 114, a zoom, angle, or frame rate of imager 110, a power supplied to blower 113, or the like), a plot other presentation of quantitative information relating at least one particle in detection chamber 102, or the like. As such, GUI 130 may offer a user zoom in and zoom out functions, individual particle images with size and/or wavelength distribution, imager sensor setup and preview in a large pop-up, on-board sensor and analysis control, pause and continue functions, restart and reselect functions, or the like.

Light source 114 is configured to generate beam 116 of light into detection chamber 102 to irradiate at least one particle within detection chamber 102 at a certain wavelength or wavelengths. In some examples, beam 116 may be collimated and or focused by a lens system, and configured to beam across detection chamber 102 to a light trap 118. Light trap may trap or stop beam 116 from reflecting back into detection chamber 102. In some examples, the light may be generated at the certain target wavelength. Alternatively, in some examples, light at a variety of wavelengths may be generated by light source 114, and light source 114 may include one or more filters, such as short-pass or long-pass filters configured to occlude light at certain wavelengths and prevent the occluded wavelengths from being beamed into detection chamber 102. Light source 114 may include a laser, LED, or another light generating device. Light source 114 may generate and/or employ a filter system such that beam 116 includes wavelengths less than 450 nanometers (nm), for example from about 250 nm to about 450 nm, or from about 250 nm to about 350 nm. Light at these wavelengths may induce fluorescence in target particles (e.g., bioaerosols) while not inducing, or only minimally inducing, fluorescence in other types of particles (e.g., abiotic particles). Light source 114 may be external, that is, located remotely from imager 110. In some examples, system 100 may include multiple light sources, which may use the same or different light generating techniques, and may generate one or more than one beam 116 at the same wavelength(s) or different wavelength(s).

Light source 114 may include a lens system configured to generate beam 116 as a collimated beam. A collimated beam may have light rays that are substantially parallel. In this way, beam 116 may focus on a particular region within detection chamber 102, such as a portion of detection chamber 102 where the gas stream containing suspended particles are configured to pass.

Imager 110 is configured to capture image data indicative of at least one particle in a region of interest in detection chamber 102. For example, imager 110 may include a lens system which makes imager 110 focused on a region of detection chamber 102 within beam 116 of light source 114. Imager 110 may be a single image sensor or camera, as illustrated, which may be configured to capture image data as elastic light scattering data, induced fluorescence data, or both. In some examples, one or more filters (e.g., short pass filters) may be included which may reduce or eliminate light of certain selectable wavelengths from reaching an array of image sensors within imager 110 such that imager 110 captures only induced fluorescence from at least one particle suspended within detection chamber 102.

In some examples, as discussed elsewhere, imager 110 may include more than one imager, such as a camera for sensing induced fluorescence (e.g., by filtering) and a camera for sensing elastic light scattering. Imager 110 may be configured to capture image data as a picture or frame (i.e., image data sensed at a particular point in time) or as video data. In some examples, a frame may refer to an overall matrix of image data captured by imager 110. The overall matrix may be made up of individual pixels, or multiple matrices made up of individual pixels (e.g., three image data matrices including a red matrix, a green matrix, and a blue matrix). Video data, as used herein, comprises a series of frames over a duration in time. In some examples, the video data may be a series of frames over a duration in time, and each respective frame in the series of frames may be separated in time from the adjacent frames by the same length of time.

Imager 110 may be a color image sensor or camera. Accordingly, imager 110 may include color sensors, which may be located in a sensor array. The color image sensor configured to detect colors in addition to black and white and capture the detected colors in one or more data matrices made up of individual pixels. Accordingly, in some examples, imager 110 may sense, capture, and record image data that includes red, green, and blue sensors, and may assign a value for red, green, and blue respectively for each pixel, creating a red matrix, a blue matrix, and a green matrix. Imager 110 or associated processing circuitry may also create an overall image data matrix. The overall image data matrix may be a sum of the red, green, and blue matrices for, and/or may be the average of the red, green, and blue matrices. Imager 110 may be configured to sense, capture, store, and/or transmit image data in a data matrix as any or all of the red matrix, green matrix, blue matrix, or overall data matrix.

Each respective matrix may include a luminance value for each pixel in the data matrix. For example, the overall data matrix may include an overall luminance value for each pixel in the overall matrix, which may be based on scaling the values in red, green, and blue matrices. As one example, the overall image data matrix may include a luma for each individual pixel, which may be a weighted sum of gamma-compressed value from each of the red image data matrix, the green image data matrix, and the blue image data matrix. In some examples, the luminance value for each pixel may be based on conversion of the overall matrix to a grayscale image that includes luminance values. The techniques described in this disclosure should not be considered limited to ways in which to determine luminance values.

In some examples, the each of the red, green, blue, and overall data matrices may include a rectangular array of pixels, such as a 1980×1080 data matrix. Processing circuitry within imager 110 or another component of system 100, such as computing device 120, may be configured to break up the overall data matrix (e.g., 1980×1080 pixels, or another matrix size) into a grid of smaller data matrices (e.g., 100×100 pixels, or another matrix size). A grid of smaller data matrices may be considered as a subset of pixels (e.g., 100×100 pixels is a subset of the 1980×1080 pixels). As described in more detail, sweeping processing across subset of pixels may allow for efficient utilization of processing capabilities, as compared to processing the overall data matrix, while ensuring that particles are properly identified in respective subsets. However, the example techniques are not so limited, and processing of the overall data matrix is also possible, as described below.

Computing device 120 may be communicatively coupled to imager 110, GUI 130, light source 114, and/or server 140, for example, by wired, optical, or wireless communications. Server 140 may be a server which may or may not be located in a particle detection laboratory, a cloud-based server, or the like. Server 140 may be configured to store image data as video data, still frame data at a particular point in time, particle information, calibration information, or the like.

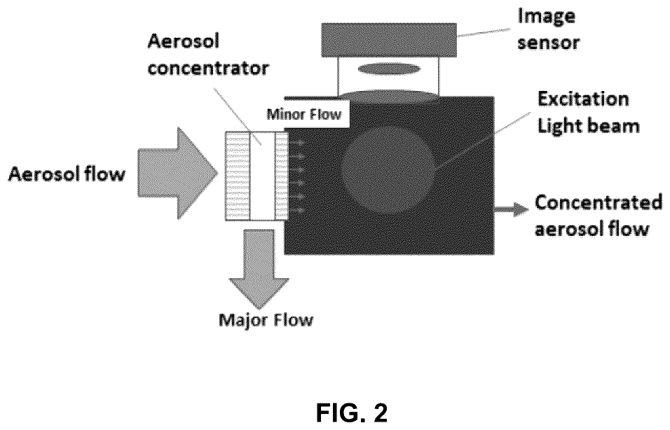

FIG. 2 is a schematic view illustrating an example suspended particle detection system according to one or more examples of the present disclosure. The system of FIG. 2 may be described similarly to system 100 of FIG. 2, differing in that the system of FIG. 2 includes a particle concentrator formed integrally with the particle detection and analysis unit. In some examples, the particle concentrator and the particle detection and analysis unit may be formed together, such as by an additive manufacturing. Such a system may be lightweight, portable, and have a relatively small footprint. Alternatively, the components may be formed separately and joined by one or more fasteners.

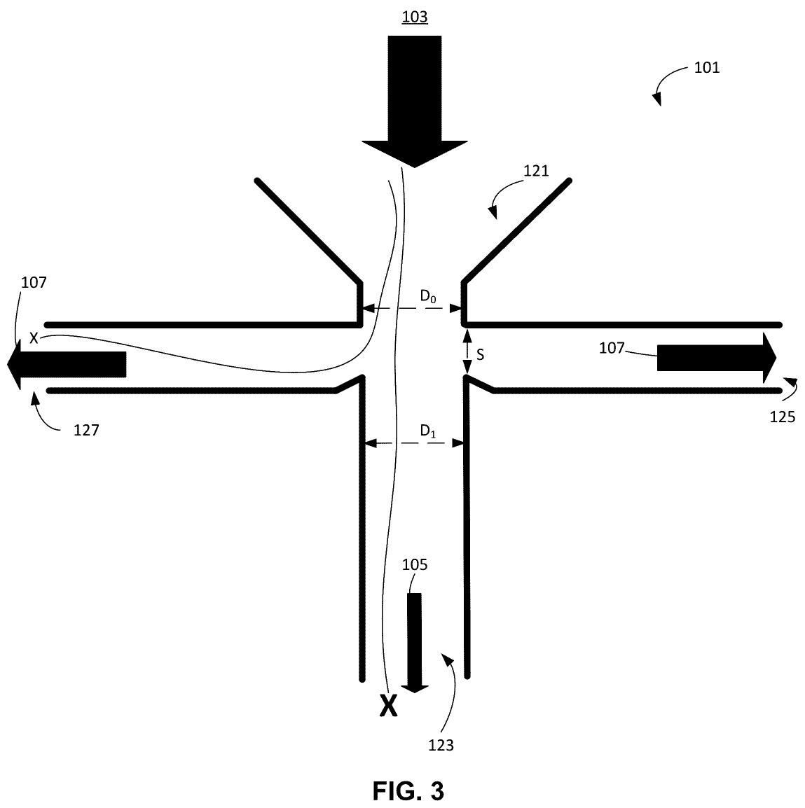

FIG. 3 is a schematic cross-sectional view illustrating a portion of a concentrating virtual impactor (CVI) type particle concentrator according to one or more examples of the present disclosure. CVI particle concentrator 101 of FIG. 3 may be all or a portion of particle concentrator 101 of FIG. 1. FIG. 3 illustrates example nozzle 121 and receiving tube 123 for particle-rich minor flow stream 105 and major flow exit channels 125 and 127 for the particle-lean major flow stream 107, and illustrates several aspects of the operation of particle concentrator 101. Particle concentrator 101 may include additional nozzles that are not illustrated, in the same stage as the illustrated nozzle or as part of another prior or subsequent stage.

In operation, aerosol 103 may be drawn or directed into nozzle 121 and receiving tube 123 using one or more blowers as described above. The volumetric flow rate of aerosol 103 may be selectively split to impact the way particles are preferentially separated into particle-rich minor flow stream 105. In some examples, blower 113 (FIG. 1) may be fluidically connected to major flow exit channel 125, major flow exit channel 127, or both, and be configured to pull a majority of the volume of aerosol 103 through particle concentrator 101 as particle-lean major flow stream 107. Similarly, the same or a different blower may be configured to pull a smaller volume of aerosol 103 through receiving tube 123 as particle-rich minor flow stream 105. Particle-lean major flow stream 107 includes a greater volumetric flow rate than particle-lean minor flow stream 105, and indicated by the larger arrows flowing from major flow exit channels 125, 127. Nozzle 121 may be disposed at an angle relative to exit channel 125 and/or exit channel 127. Although illustrated in FIG. 3 as an angle of about 90 degrees, in some examples the angle may be such that a line defined by the respective flow streams forms an angle in a range of from about 90 degrees to about 180 degrees. In some examples, major flow exit channel 125 may substantially surround receiving tube 123, (e.g., as an outer sleeve surrounding an inner sleeve. Other configurations are also considered.

FIG. 3 illustrates the trajectory of two different particles passing through nozzle 121. A particle with a maximum dimension below the particle size cutoff point is illustrated as the small x. A particle with a maximum dimension above the particle size cutoff point is illustrated as the large X. Particles with a maximum dimension below the particle size cutoff have too little inertia and follow the flow streamlines into both the minor flow stream 105 and major flow streams 107 in the same proportion as they are present in bulk aerosol 103. In other words, small particles are not preferentially separated, as indicated by the small particle in the illustration of FIG. 3 being directed into major flow channel 127 and becoming part of particle-lean major flow stream 107. Conversely, the large particle, indicated by the large X, has enough inertia to enter receiving tube 123, becoming part of particle-rich minor flow stream 105.

As illustrated in FIG. 3, the aperture defined by nozzle 121 is Do, the separation between the inlet nozzle 121 and receiving tube 123 is S, and the aperture defined by receiving tube 123 is D1. Each dimension may be tailored, along with the flow rate through each nozzle and receiving tube by manipulation of the power to blower(s) (113, FIG. 1), to interact to define a particle size cutoff point. The particle size cutoff point is the point at which the maximum dimension of the particle reaches a threshold that determines whether the particle is preferentially separated into particle-rich minor flow stream 105. Particles with a maximum dimension above the particle size cutoff point are preferentially separated such that a majority of particles with the same or a larger maximum dimension have enough inertia to enter receiving tube 123 and output with particle-rich minor flow stream 105. Particles with a maximum dimension below the particle size cutoff point follow the flow streamlines such that a majority of particles with the same or a smaller maximum dimension enter exit channels 125, 127 and are output with particle-lean major flow stream 107. Further discussion is available in the following article: F. J. Romay, D. L. Roberts, V. A. Marple, B. Y. H. Liu & B. A. Olson (2002) A High-Performance Aerosol Concentrator for Biological Agent Detection, Aerosol Science & Technology, 36:2, 217-226, DOI: 10.1080/027868202753504074, the entire contents of which is incorporated herein by reference. In some examples, the particle size cutoff point may be about 1.0 micrometer.

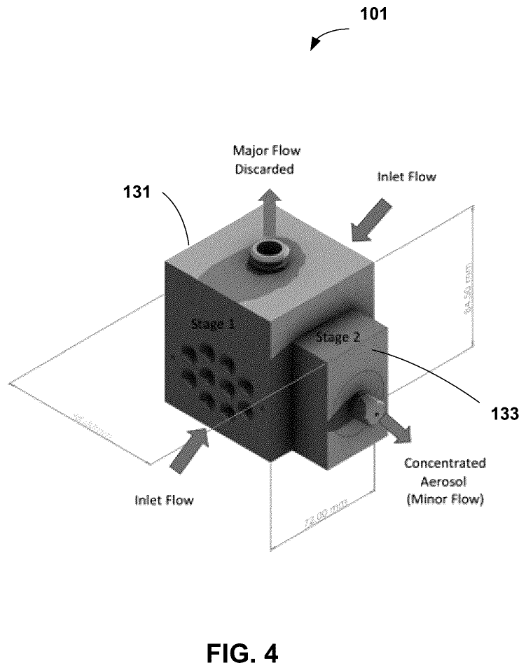

FIG. 4 is a schematic perspective view illustrating particle concentrator 101 of FIG. 1. FIG. 4 is included to illustrate that particle concentrator 101 may be a multi-stage (in this example, two stages, but one, three, and four-stage concentrators are considered). First stage 131 (rear left) includes a first set of nozzles and corresponding receiving tubes. Each nozzle has a corresponding aerosol inlet, as shown. The particle-rich minor flow stream is then fed to second stage 133 including a second set of nozzles. In the illustrated example, second stage 133 includes only a single nozzle and corresponding receiving tube. Inclusion of multiple stages, with nozzles arranged both in parallel and in series, may allow for a high concentration ratio in a relatively small device. Accordingly, particle concentrator 101 may concentrate an aerosol 103 at extremely low concentration in the bulk gas to a second concentration that includes at least 20 times more particles per unit volume than aerosol 103. In some examples, particle concentrator 103 may define a greatest dimension (e.g., any of length, width, or height) of less than about 150 millimeters. Thus, the system may be applicable to portable and/or cramped spaces.

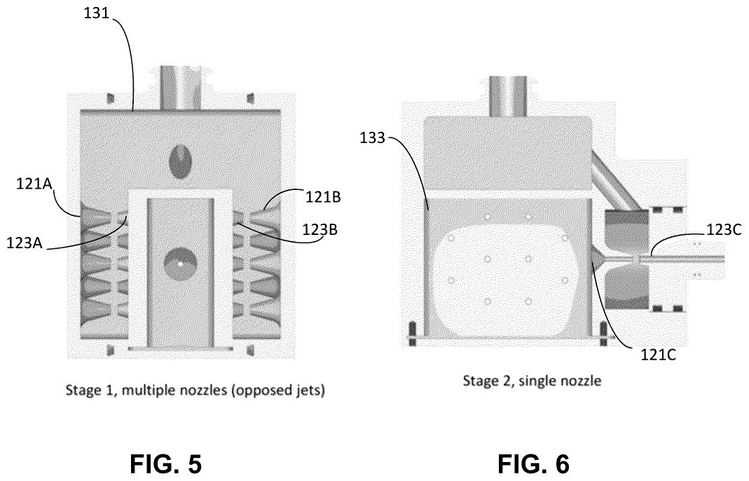

FIGS. 5 and 6 are schematic cross-sectional views illustrating example stages of a particle concentrator according to the present disclosure. FIG. 5 is a cross-sectional view of first stage 131 of FIG. 4, while FIG. 6 is a cross-sectional view of second stage 133 of FIG. 4. First stage 131 includes a plurality of nozzles, only two of which are labeled for clarity as 121A and 121B. Each nozzle is paired with a corresponding receiving tube 123A, 123B. Second stage 133, which may be disposed downstream of first stage major flow cavity 131, includes a single nozzle 121C and corresponding receiving tube 123C. The major flow of stage 2 is combined with the stage 1 major flow.

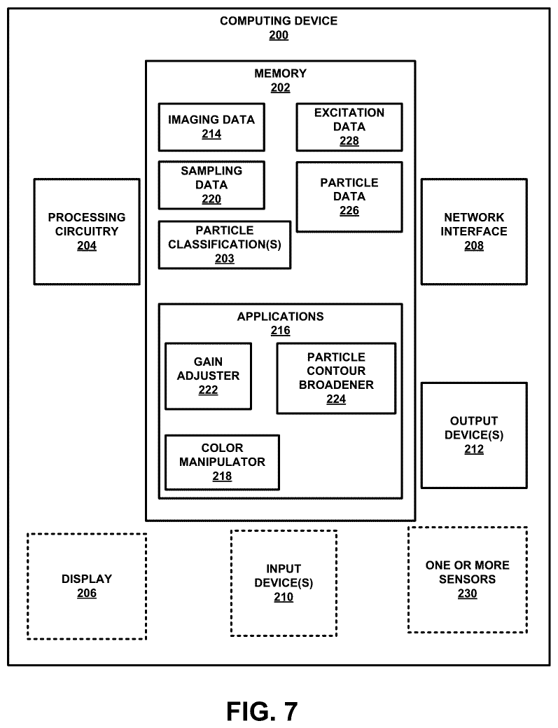

FIG. 7 is a block diagram of example computing device 200 in accordance with one or more aspects of this disclosure. Computing device 200 may be an example of computing device 120, workstation 115, and/or server 140 of FIG. 1 and may include a workstation, a desktop computer, a laptop computer, a server, a smart phone, a tablet, a dedicated computing device, or any other computing device capable of performing the techniques of this disclosure.

In some examples, computing device 200 may be configured to perform image processing, control and other functions associated with workstation 115, imager 110, light source 114, blower 113, or other function of system 100 of FIG. 1. As shown in FIG. 7, computing device 200 represents multiple instances of computing devices, each of which may be associated with one or more of workstation 115, imager 110, light source 114, or other elements. Computing device 200 may include, for example, a memory 202, processing circuitry 204, a display 206, a network interface 208, an input device(s) 210, or an output device(s) 212, each of which may represent any of multiple instances of such a device within the computing system, for ease of description.

While processing circuitry 204 appears in computing device 200 in FIG. 7, in some examples, features attributed to processing circuitry 204 may be performed by processing circuitry of any of computing device 120, workstation 115, imager 110, server 140, light source 114, or combinations thereof. In some examples, one or more processors associated with processing circuitry 204 in computing device 200 may be distributed and shared across any combination of computing device 120, workstation 115, imager 110, server 140, light source 114, or other elements of FIG. 1. Additionally, in some examples, processing operations or other operations performed by processing circuitry 204 may be performed by one or more processors residing remotely, such as one or more cloud servers or processors, each of which may be considered a part of computing device 200. Computing device 200 may be used to perform any of the techniques described in this disclosure, and may form all or part of devices or systems configured to perform such techniques, alone or in conjunction with other components, such as components of computing device 120, guidance workstation 115, imager 110, server 140, or a system including any or all of such devices.

Memory 202 of computing device 200 includes any non-transitory computer-readable storage media for storing data or software that is executable by processing circuitry 204 and that controls the operation of computing device 120, workstation 115, imager 110, or server 140, as applicable. In one or more examples, memory 202 may include one or more solid-state storage devices such as flash memory chips. In one or more examples, memory 202 may include one or more mass storage devices connected to the processing circuitry 204 through a mass storage controller (not shown) and a communications bus (not shown).

Although the description of computer-readable media herein refers to a solid-state storage, it should be appreciated by those skilled in the art that computer-readable storage media may be any available media that may be accessed by the processing circuitry 204. That is, computer readable storage media includes non-transitory, volatile, and non-volatile, removable and non-removable media implemented in any method or technology for storage of information such as computer-readable instructions, data structures, program modules, or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium that may be used to store the desired information and that may be accessed by computing device 200. In one or more examples, computer-readable storage media may be stored in the cloud or remote storage and accessed using any suitable technique or techniques through at least one of a wired or wireless connection.

Memory 202 may store one or more applications 216. Applications 216 may include a gain adjuster 222, a particle contour broadener 224, color manipulator 218, and/or other computer vision model(s) or machine learning module(s), such as a model to determine particle contours in sensed image data, broaden particle contours to determine broadened particle contours, determine a particle boundary based on the broadened particle contours, or the like. Applications 216 stored in memory 202 may be configured to be executed by processing circuitry 204 to carry out operations on imaging data 214 of at least one particle within detection chamber 102 (FIG. 1). Although separate instructions for processing circuitry 204 are described as residing within certain applications 216, it should be understood that the described functionality assigned to, for example gain adjuster 222, may be assigned to different applications, for example, particle contour broadener 224 or color manipulator 218, or combinations of applications. In other words, instruction for processing circuitry are only described as residing within particular applications for case of understanding.

Memory 202 may store imaging data 214 and excitation data 228. Imaging data 214 may be captured by one or more sensors within or separate from imager 110 (FIG. 1) during a particle detection operation. Processing circuitry 204 may receive imaging data 214 from one or more image sensors within imager 110 and store imaging data 214 in memory 202, for example as a frame which includes the red matrix, green matrix, blue matrix, overall matrix, or combinations thereof. Sampling data 220 may be generated by imager 110, pump 108 or other components of FIG. 1 and processing circuitry 204 facilitate storage of sampling data 220. Excitation data 228 (e.g., wavelength(s), intensity, focus area, etc.) may be generated by light source 114, and processing circuitry 204 may facilitate storage of excitation data 228 within memory 202.

Processing circuitry 204 is configured to generate at least one of quantitative or qualitative information for the at least one particle within detection chamber 102. The quantitative data may include one or more of a particle count, particle size, and or a particle concentration, and/or how these or other quantitative data change over time (e.g., from frame to frame in a video file). Example qualitative data may include one or more of a particle category (e.g., bioparticle or abiotic particle) or particle species (e.g., specific bioparticle), particle image of a particular particle, or the like. Qualitative data may be generated by comparing imaging data 214 to stored particle data 226 and particle classifications 203. Stored particle data 226 may include calibration data of known particle size, count, concentration, category, species or the like. Processing circuitry 204 may register imaging data 214 and/or excitation data 228 using timestamps (which may be placed in the data by, for example, imager 110, computing device 120, or workstation 115). Processing circuitry 204 may output for display by display 206, e.g., to GUI 130 of FIG. 1, imaging data 214 converted to quantitative and/or qualitative information about at least one particle by processing circuitry 204, for example by a plot or chart.

In some examples, processing circuitry may perform an analysis technique on stored imaging data 214, which may be called analysis mode operation. Processing circuitry 204 may be configured to output for display on GUI 130 of FIG. 1 an option for a user to select an image file from imaging data 214. Processing circuitry 204 may be configured to determine whether the selected file is readable, and responsive to determining that the file is readable, read a frame from the file. Processing circuitry 204 may be configured to employ one or more applications 216 to analyze image data stored within the file to identify at least one particle in the frame and generate quantitative information and/or qualitative information about the at least one particle.

In some examples, processing circuitry 204 may perform a real-time particle detection and analysis technique. Processing circuitry 204 may receive image data directly from imager 110, or from imaging data 214 stored in memory 202, and, in substantially real time, capture a first frame of the sensed image data representing data sensed at a first time. Substantially real-time, as used herein, may mean that the image data is captured and analyzed without stopping the imager 110, that is, during the sampling operation. Processing circuitry 204 is configured to analyzing image data in the frame to identify at least one particle, convert image data within the frame to quantitative information about the at least one particle within the frame at the first time, and capture a second frame of the sensed image data representing data sensed at a second time.

Processing circuitry 204 may be configured to execute color manipulator 218 to generate grayscale image data from color image data sensed by imager 110. Alternatively, processing circuitry 204 may facilitate receipt of grayscale image data. Regardless, grayscale image data may be obtained by processing circuitry 204 for analysis. The grayscale image data may be the overall image data matrix, which may be created by scaling of each of the red, green, and blue matrices. The resulting grayscale image data may include a luminance value for each pixel in an image data matrix, as described above.

Processing circuitry 204 may be configured to determine particle contours of at least one particle in detection chamber 102 in the sensed the image data based on the luminance values of the grayscale image, or of other image data. For example, the luminance value of a particular pixel may be relatively high, indicating the presence of an irradiated particle in the location of the pixel in the grayscale image. Particle contours, as described herein, may be a particle boundary, but due to the small size and irregular shape of some particles, particle contours may in some examples only represent a feature (e.g., a spike) on a particle. In some examples, particle contours may be lights spots (e.g., pixels with relatively higher luminance values) that satisfy a threshold. One example of the threshold is an average of a subset of pixels, and pixels within that subset that are greater than the threshold are part of the particle contours.

That is, processing circuitry 204 may determine that, when a particular pixel satisfies a threshold, the pixel is part of the particle contours of a particle. Adjacent pixels that all satisfy the threshold may be grouped together as a group of pixels that form an island (or a “spot”) of particle contours. In some examples, processing circuitry 204 may be configured to identify pixels having luminance values that satisfy the threshold by determining local thresholds within respective subsets of pixels (e.g., each respective small matrix in a grid of small matrices making up the overall matrix). Processing circuitry 204 may be configured to compare luminance values of pixels within each respective subsets of pixels to respective local threshold for that subset of pixels. Then, processing circuitry 204 may be configured to sweep through the subsets to pixels to identify the pixels based on the comparison, and determine particle contours by grouping the identified pixels of each of the respective subsets of pixels together as an island of particle contours. In other words, in some examples, the threshold may be assigned as the average value of a small matrix (e.g., a subset of the overall number of pixels, such as a 100×100 matrix of pixels) in which the particular pixel resides, and each individual pixel above the average of the small matrix in which it resides may be assigned as belonging to an island of particle contours.

In some examples, the threshold may be assigned as the average luminance value of the entire image data matrix (e.g., a 1980×1080 matrix of pixels) and each individual pixel with a luminance value above the average may be assigned as part of a group of proximate pixels an island of particle contours. In some examples, the threshold may be set by a fitting function. In some examples, the fitting function may use both the small matrix in which the particle resides and the overall matrix to determine whether an individual pixel is part of the particle contours. In some examples, processing circuitry 204 may execute a fitting function to identify particular pixels within the small matrix as being part an of island of particle contours. In some examples, the fitting function may be a Gaussian function, an adaptive mean threshold, an adaptive Gaussian function, combinations thereof, or another fitting function.

In some examples, processing circuitry 204 may be configured to determine particle contours in other ways. For example, processing circuitry may scan the grayscale image to find a local peak. The local peak may be found when processing circuitry 204 determines that a difference value indicative of a difference between luminance values of proximate pixels satisfies a threshold; and based on the difference value satisfying the threshold, determines that one of the pixels (e.g., the pixel with the higher luminance value) is part of the particle contours for the at least one particle. In some examples, processing circuitry may scan surrounding pixels for other local peaks. In some examples, processing circuitry 204 may determine that all local peaks within a certain number of pixels from each other are part of the same island of particle contours. For example, where a local peak is found within 1, 2, 3, 4, 5, or other number of pixels of another local peak, processing circuitry 204 may connect the local peaks as part of the same particle contours.

In some examples, before executing the algorithm or function configured to determine particle contours, processing circuitry 204 may be configured to reduce or eliminate macroscale differences in luminance values due to imager 110, light source 114, and/or detection chambers by executing gain adjuster 222. In some examples, gain adjuster 222 may adjust (e.g., change) the average luminance value of each individual pixel within a small matrix within the grid of small matrices. In this way, the overall image data matrix may be normalized to account for trends in average luminance values on a macro level, such that each grid may have the same or a similar average luminance value relative to the rest of the small matrices within the grid.

It may be possible that counting each island of particle contours may result in overcounting and/or under-sizing particles, because two or more spikes or other topographical features on the same particle may show up as individual islands of particle contours in the luminance values of the image data. That is, two individual islands may be for the same particle, but appear to be for different particles, and therefore, two particles are counted for one particle. Processing circuitry 204 may be configured to execute one or more applications configured to address such possible overcounting. For example, processing circuitry 204 may determine a particle boundary based on the determined particle contours broadening the determined particle contours and may determine a particle boundary based on the broadened particle contours. For example, applications 216 may include particle contour broadener 224, which may store instructions for processing circuitry to execute such an operation.

Processing circuitry 204 may execute the particle contour broadener 224 application, which may be housed within memory 202 of computing device 204. Particle contour broadener 224 may be configured to adjust (e.g., change by increasing or decreasing) the luminance value for individual pixels within the overall image data matrix (e.g., 1980×1080 pixels). Particle contour broadener 224 may be configured to adjust (e.g., increase or decrease) the luminance values of the image data to assist in determining a particle boundary from sensed particle contours. For example, particle contour broadener 224 may be configured to group several small islands of particle contours together to define a particle boundary that includes each of the more than one islands of particle contours as one particle by defining a boundary around both of the islands. For example, particle contour broadener 224 may be configured to broaden the particle contours by assigning additional pixel points around an identified spot or island the same luminance value as a neighboring pixel, such that particle contour broadener 224 may connect small spots very close to each other as a big spot to avoid over-counting one big particle as many small particles.

In some examples, processing circuitry 204 may determine broadened particle contours by determining that the identified pixels include a first pixel and a second pixel that are separated by a distance. Processing circuitry 204 may be configured to assign one or more pixels, within the distance, proximate to the first pixel and second pixel approximately the same luminance value as nearest pixel within identified pixels to create a broadened cluster of pixels that include the first pixel and the second pixel; and determine the particle contours based on the cluster of pixels.

Accordingly, particle contour broadener 224 may reduce overcounting and/or under-sizing of particles, because particles with topography that is sensed and stored as image data that includes separate islands of particle contours connects the small spots together as one larger spot, and correctly counts and sizes the multiple spots as a single particle. In some examples, particle contour broadener 224 may be configured to broaden the sensed particle contours by increasing the luminance values of one or more pixels proximate to the sensed particle contours to define broadened particle contours. For example, each pixel within 1, 2, 3 or more pixels from a sensed local peak, or from a pixel that is part of a particle contour, may be assigned the same luminance value as the luminance value of the local peak or member pixel of a particle contour. In this way, each island of particle contours may be stretched in size to define broadened particle contours. In some examples, user input may indicate how many neighboring pixels should have their luminance value adjusted, based on user knowledge of particle size or particle topography, or by experimentation (e.g., comparison against a calibration sample of known particle size or particle size distribution).

Additionally, or alternatively, particle contour broadener 224 may execute one or more computer vision or machine learning modules to determine how sensed particle contours should be stretched to determine broadened particle contours. In some examples, a fitting function may be executed to determine broadened particle contours. In some examples, the fitting function may be a Gaussian function, an adaptive mean threshold, an adaptive Gaussian function, combinations thereof, or another fitting function.

Once processing circuitry 204 has executed particle contour broadener 224 to determine broadened particle contours, processing circuitry may execute instructions to determine a particle boundary from the broadened particle contours. Stated similarly, processing circuitry 204 may be configured to determine which individual islands of particle contours in the sensed image data should be grouped together and assigned as belonging to the same particle, such that the particle boundary may be determined around the islands which are part of the same particle. In some examples, determining a boundary may include determining whether the broadened particle contours intersect with another spot or island of broadened particle contours. Based on determining that there is no intersection between the broadened particle contours, processing circuitry 204 may determine that the particle contour in the image data is a boundary of a particle. Conversely, based on the determination that there is intersection, determining that the particle contours and the other broadened particle contours together belong to the same particle, and connecting the islands of particle contours, and a line or curve set by a fitting function connecting the islands forms a boundary for the particle. As such, the determination that there is intersection between the broadened particle contours may include determining that the intersecting particle contours form a boundary for the at least one particle.

Once a particle boundary has been determined based on the broadened particle contours, processing circuitry 204 may be configured to mark the pixels within the boundary as making up an individual particle. Processing circuitry 204 may be configured to count the marked particles, size the particles within the image data by correlating the number of pixels to a scale that maps that the pixels to a map of the detection chamber and/or a zoom setting of the lens system of imager 110, and determine the concentration of particles within the gas stream based on the marked particles and sampling information. As such, processing circuitry 204 may generate quantitative information based on the determined particle contours.

Processing circuitry 204 may execute the color manipulator 224 application, which may be housed within memory 202 of computing device 204. Processing circuitry 204 may execute color manipulator 218 to perform color analysis received color image data. The color image data may be from imager 110, which may be a color image sensor or a color video camera. The color image data may include colors in addition to black and white, such as one or more of red, green and blue colors.

In some examples, color manipulator 224 may store instructions for processing circuitry 204 to perform color analysis based on the determined particle boundary from the luminance analysis technique with the grayscale image data described above. For example, color analysis may be performed using the determined particle boundary as described above. Processing circuitry 204 may be configured to use determined particle boundary to locate a particle area in the color image data, such as by overlaying the determined particle boundary over the color image data from imager 110. Processing circuitry 204 may be configured to determine a dominant color within the particle area. In some examples, the dominant color may be the hue that appears most frequently within the particle area. In some examples, the dominant color may be the average of red, green, and blue values of pixels within the particle area. Processing circuitry 204 may convert the dominant color to the dominant wavelength of the particle by using the hue of the dominant color calculate the wavelength of induced fluorescent light emitted by the particle. The color image data may be signals sensed at red, green, and blue pixels in a sensor array of imager 110.

Processing circuitry 204 may be further configured to compare the dominant wavelength of the particle to a database of known wavelengths of particles stored within memory 202 as particle data 226. Since certain particles induce fluorescence at known wavelengths when irradiated with beam 116 of known wavelength, processing circuitry may thus determine a particle species when the dominant wavelength matches, or is within a certain tolerance, of a known particle species stored in the database. Similarly, memory 202 may store particles classification database(s) 203. These databases may use the dominant wavelength, size of the particle area, shape of the particle area, particle images of specific particles, or the like to classify particles by matching these features against known particle parameters stored within the database. For example, processing circuitry 204 may be configured to determine whether the particle is a bioaerosol or abiotic aerosol. Thus, processing circuitry 204 may be configured to generate qualitative information about at least one particle based on the determined particle contours.

In some examples, processing circuitry 204 may be configured to aggregate the results of frames of image data from imager 110, such as a first set of image data captured at a first time and a second set of image data captured at a second time. Processing circuitry 204 may be configured to output for display via display 206 a representation the first set of image data, the second set of image data, or both sets of image data. In some examples, the representation of the image data may be in the form of a chart, table or graph.

Advantageously, system 100 and its associated techniques for operation may be suitable for detecting and analyzing smaller particles and/or particles at lower concentrations than other particle detection and image processing techniques, because system 100 may process the sensed data to more accurately determine at least one of the shape, size, count, concentration, type, or species of particle.

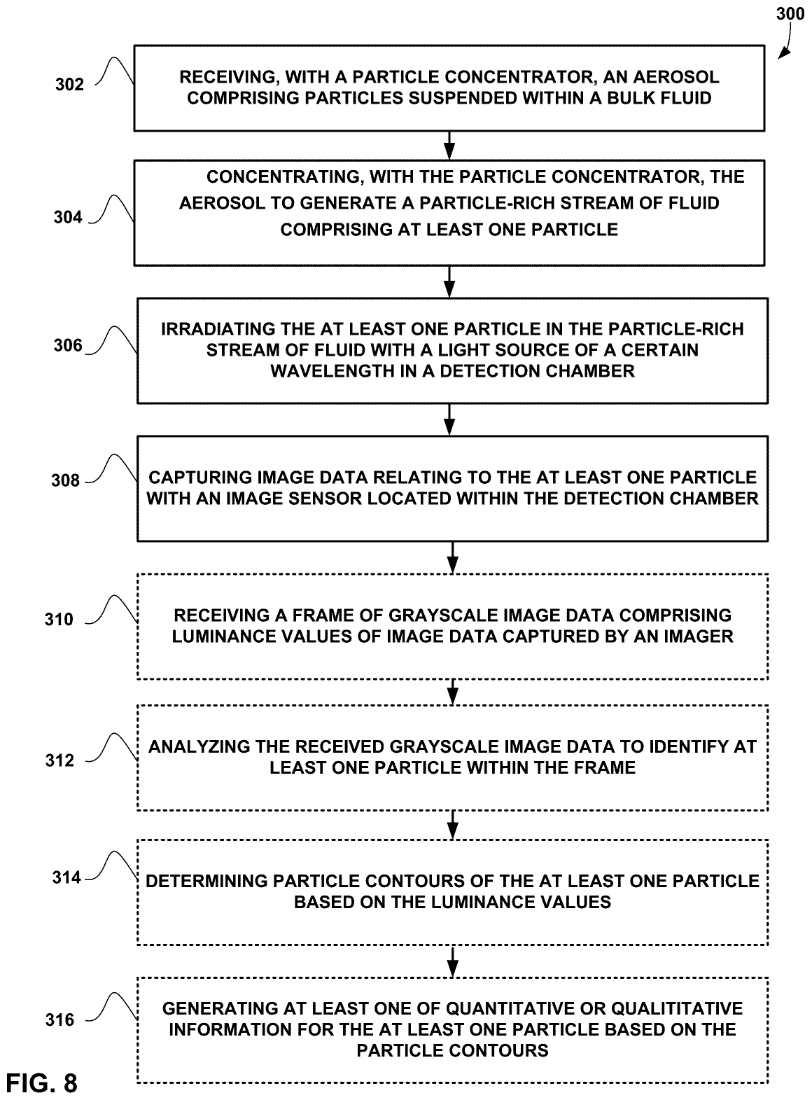

FIG. 8 is a flowchart illustrating an example particle analysis technique 300 in accordance with one or more aspects of the present disclosure. Although the illustrated technique is described with respect to, and may be performed by, system 100 of FIG. 1 and computing device 200 of FIG. 7, it should be understood that other systems and computing devices may be used to perform the illustrated technique. Technique 300 includes receiving, with particle concentrator 101, an aerosol 103 which includes particles suspended within a bulk gas (302). Technique 300 further includes concentrating, with particle concentrator 101, aerosol 103 to generate a particle-rich stream of gas 105, which includes at least one particle (304).

Additionally, technique 300 of FIG. 3 includes irradiating the at least one particle in the particle-rich stream of gas 105 (306). The particle may be irradiated by beam 116 from light source 114 while the particle is in detection chamber 102, which may include light at a certain wavelength or range of wavelengths. Furthermore, technique 300 includes capturing image data relating to the at least one particle with image sensor 110 located in detection chamber 102 (308).

The image data from imager 110 may be processed in any way. For example, technique 300 may optionally include receiving a frame of grayscale image data comprising luminance values of image data captured by imager 110 (310). Processing circuitry 204 may analyze the received image data to identify at least one particle within the frame (312). In some examples, technique 300 may include determining particle contours of the at least one particle based on the luminance values (314). Technique 300 optionally includes generating, by processing circuitry 204, at least one of quantitative or qualitative information for the at least one particle based on the determined particle contours (316). In some examples, technique 300 may further include irradiating particles within detection chamber 102 by projecting beam 116 into the detection chamber. Beam 116 may comprise light ray(s) with a wavelength of less than about 450 nm, such as from about 250 nm to about 350 nm. In some examples, technique 300 may include capturing imaging data 214 (FIG. 2) with imager 110 (e.g., a color video camera). As discussed above, the imaging data may be induced or enhanced by light source 114, which may be external to imager 110.

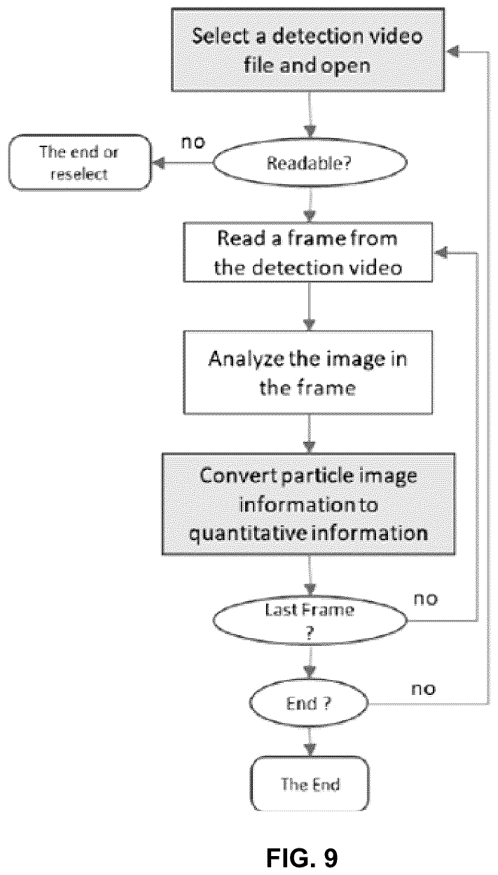

FIG. 9 illustrates an example particle detection and analysis technique according to one or more aspects of the present disclosure. The technique includes selecting a file from an image sensor or camera 110, which may be stored as imaging data 214 in memory 202. The technique includes determining, by processing circuitry 204, whether the file is readable. Responsive to determining that the file is readable, the technique includes reading a frame from the file by processing circuitry 204. In some examples, the frame may represent image data sensed at a particular point in time. The technique includes analyzing, by processing circuitry 204, image data in the frame to identify at least one particle. The technique further includes converting, by processing circuitry 204, image data within the frame to quantitative information about the at least one particle. Optionally, the technique includes determining, by processing circuitry 204, whether the read frame is the last frame in the file. Responsive to determining that the read frame is not the last frame, the technique may optionally include reading a second frame from the file by processing circuitry 204. The second frame may be separated from the first frame by an adjustable duration of time, such that frame-by frame particle analysis may be conducted.

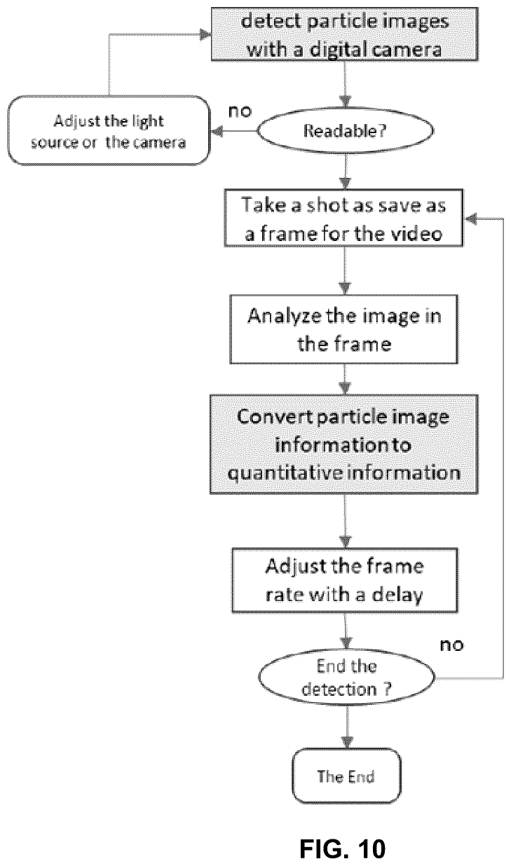

FIG. 10 is a flowchart illustrating an example real-time particle detection and analysis technique in accordance with one or more aspects of the present disclosure. The technique of FIG. 10 may be performed on particle-rich stream of gas 105 by particle detection and analysis unit 111. Although the illustrated technique is described with respect to and may be performed by system 100 of FIG. 1 and computing device 200 of FIG. 7, it should be understood that other systems and computing devices may be used to perform the illustrated technique. The technique includes receiving, by processing circuitry 204, image data from an imager 110. Imager 110 may be an image sensor or sensors or a camera or cameras, or a combination of sensors and cameras which may be located remotely from each other within detection chamber 102, may be configured to capture image data in different ways (e.g., induced fluorescence data or elastic light scattering data). Processing circuitry 204 may be configured to receive the image data in substantially real-time. The technique includes capturing, by processing circuitry 204, a first frame of the sensed image data representing data sensed at a first time, illustrated as “take a shot as save as a frame for the video.” The technique includes analyzing, by processing circuitry 204, the image data in the frame to identify at least one particle in the image data. The technique includes converting, by processing circuitry 204, image data within the frame to quantitative information about the at least one particle within the frame at the first time. The technique further includes, capturing, by processing circuitry, a second frame of the sensed image data representing data sensed at a second time. Optionally, the technique includes adjusting the frame rate with a delay, such that the duration of time between the first time and the second time is controlled. The frame rate may be controlled by processing circuitry 204 to allow a regular duration of time between successive frames, or may be input by a user through GUI 130 to manually capture frames at a selected time of interest. The technique optionally includes repeating the process with a third frame representing a third time, a fourth frame representing a fourth time, and so on. In some examples, the quantitative information may include one or more of a particle count, a particle concentration, an image size distribution, a wavelength distribution of induced fluorescence, or the like. The particle concentration, image size distribution, and wavelength distribution may be calibrated using particles of known concentrations, image sizes, and wavelengths.

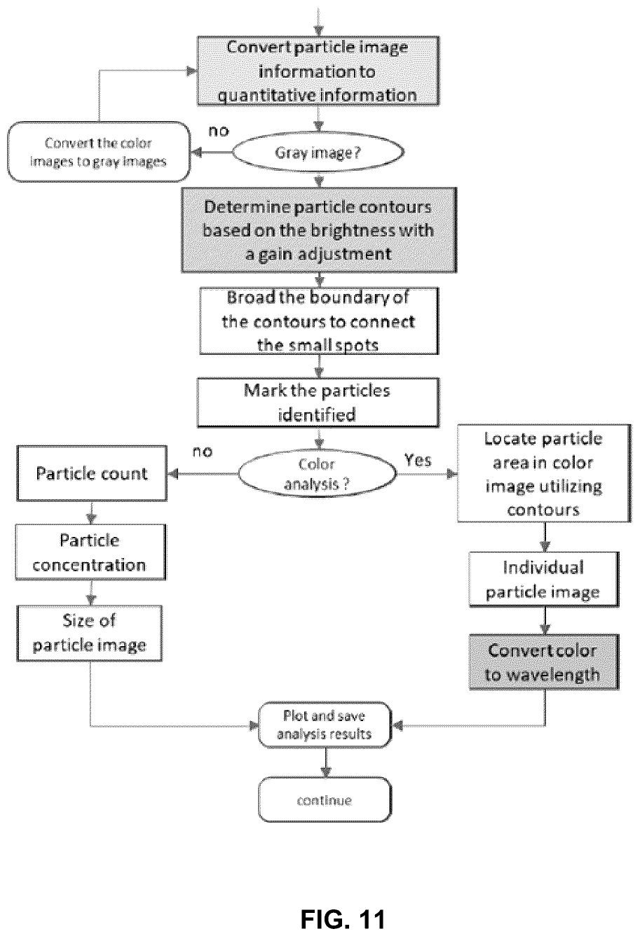

FIG. 11 illustrates an example technique for converting sensed image data to quantitative and/or qualitative information about at least one particle. The technique of FIG. 11 may be an example of technique 300 of FIG. 8. The technique used to convert sensed image data to quantitative and/or qualitative information about at least one particle in the illustrated techniques of FIGS. 9 and 10, although other techniques may be employed to generate quantitative information in those techniques. Furthermore, the technique of FIG. 11 will be described with respect to system 100 of FIG. 1 and computing device 200 of FIG. 7, although the illustrated technique may be executed using other systems and computing devices.

The technique of FIG. 11 may include determining, by processing circuitry 204, whether the image is a gray image, and responsive to determining that the image is not a gray image, converting the image to a gray image. Color manipulator 218 may instruct Processing circuitry 204 may instruct processing circuitry 204 to the sensed and captured image data to change all or a portion of the captured image data to a gray image.

In some examples, the technique of FIG. 11 may include determining, by processing circuitry 204, particle contours of at least one particle in the image data sensed by imager 110. Processing circuitry 110 may base the particle contours on the image brightness The raw image data may be manipulated by gain adjuster 222 to increase or decrease the brightness in portions of the frame of sensed image data to determine an adjusted image brightness, which may be contained within luminance values of each pixel in a matrix of pixels making up the frame of image data. In some examples, the quality of determination of the contours may be evaluated by checking the ratio of the particle recognized to a known calibration sample of particles, and modifying processing circuitry 204 based on particle count differences, concentration differences, particle size or size distribution differences, particle type, or particle category differences between the known sample and the image data. For example, some particles in the calibration sample may be over or under recognized, and the settings of particle contour broadener 224 may be manipulated to more accurately capture the calibration sample. In the case of two or more parameters needed to change to determine the particle contours, in some examples only one may be selected as controllable by input by a user into GUI 130 and others may be pre-set by processing circuitry 204, to make the operation simple.

In some examples, the technique of FIG. 11 may include broadening the boundary of the determined particle contours by processing circuitry 204 through the particle contour broadener 224 application. The boundaries may be broadened by a selectable amount, such as, for example, 1 pixel, 2 pixels, 3 pixels, 1.5×, 2×, 3×, or the like, based on a user input. Additionally, or alternatively, one or more algorithms executed by processing circuitry 204 to determine how the sensed particle contours are broadened. For example, a user may input one setting, and processing circuitry 204 may execute a fitting function (e.g, a Gaussian function) to determine broadened particle boundaries. Furthermore, in some examples, processing circuitry 204 may, by recognizing where the adjusted (e.g., broadened) boundaries overlap, connect spots or islands of particle contours within the frame such that separate spots become one particle, and may be counted as such. Next, the technique of FIG. 11 may include marking, by processing circuitry 204, identified particles in the frame based on the determined particle contours. Discrete particles may be marked where the broadened particle contours do not overlap. Then, the technique of FIG. 11 may include counting, by processing circuitry 204, particles within the frame based on the broadened boundaries. The particle concentration may be calculated based on the particle count and sampling data 220, which may include the volume of detection chamber 102, the flow rate of gas through inlet 104, the energy supplied to pump 108, or the like. In some examples, the technique of FIG. 11 may include determining, by processing circuitry 2014, a size of at least one particle within the frame. The particle size may be based on image data from imager 110.

The technique of FIG. 11 may include only performing the steps on the left side of the color analysis split in FIG. 11. However, in some examples, the technique of FIG. 11 may also include performing color analysis. In some examples, the color analysis technique of FIG. 11 may be employed on the original color image captured by imager 110. Performing color analysis may include locating, by processing circuitry 204, a particle area in the frame color image utilizing contours, as described above. In some examples, performing color analysis may include converting, by processing circuitry 204, color to wavelength by using the hue of color in the color image to calculate the wavelength of induced fluorescent light, as will be further described below. Converting color to wavelength by processing circuitry 204 may be based at least partially on the signals sensed at red, green, and blue pixels in a sensor array of image sensor 110.

In some examples, the technique of FIG. 11 may include comparing, by processing circuitry 204, the wavelength of induced fluorescence of an identified particle to a database of known wavelengths of particles stored as particle data 226 in memory 202. In some examples, a threshold for comparing the wavelength of the sensed particle may be met, and a particle species may be determined. Similarly, the technique of FIG. 11 may include, by comparing, with processing circuitry 204, the sensed color image to a particles classification database 203 stored in memory 202. Processing circuitry 204 may determine whether the particle type is a bioaerosol or an abiotic aerosol.

In some examples, the technique of FIG. 11 may include outputting, by processing circuitry 204, for display via a display such as GUI 130, a representation of one or more pieces of quantitative information from the frame of sensed data. The quantitative information may include one or more of a particle count, a particle size, a particle concentration, a particle type, or a particle species. The technique of FIG. 11 may include displaying the results on a display, such as a display associated with GUI 130.

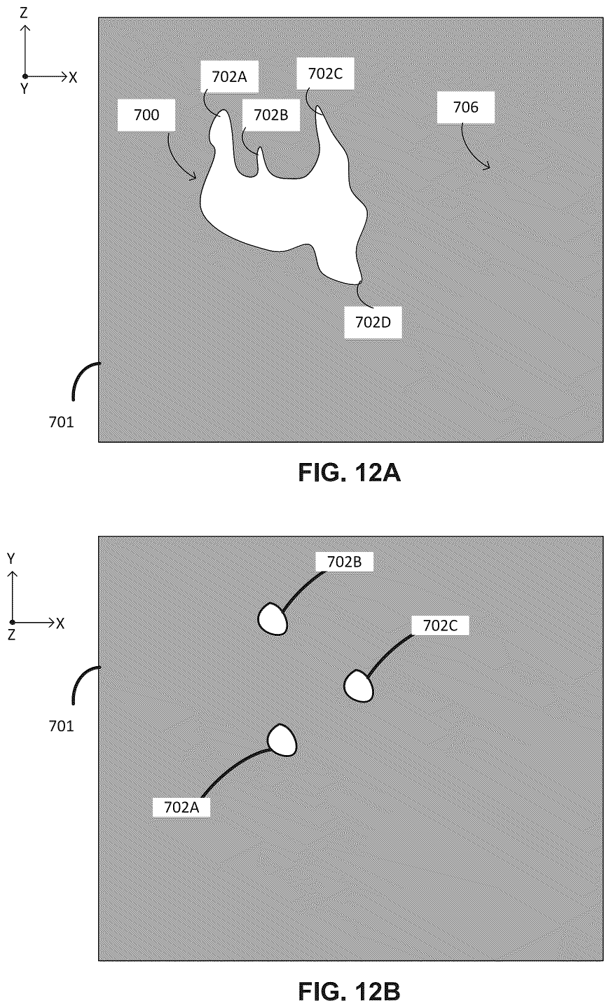

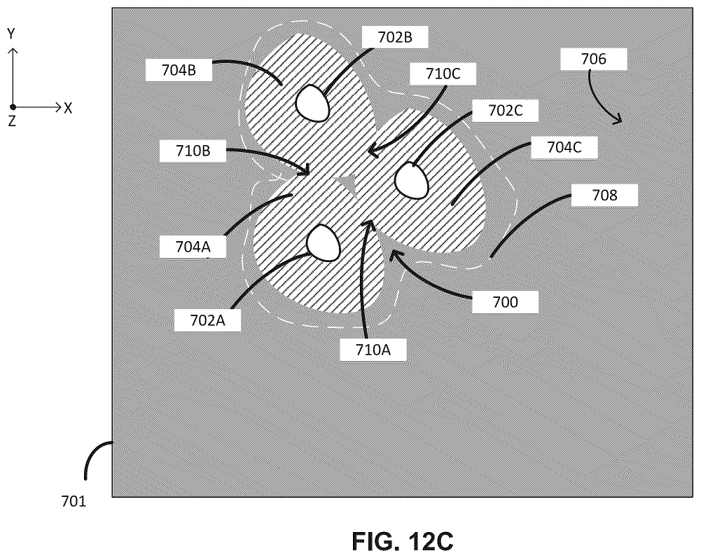

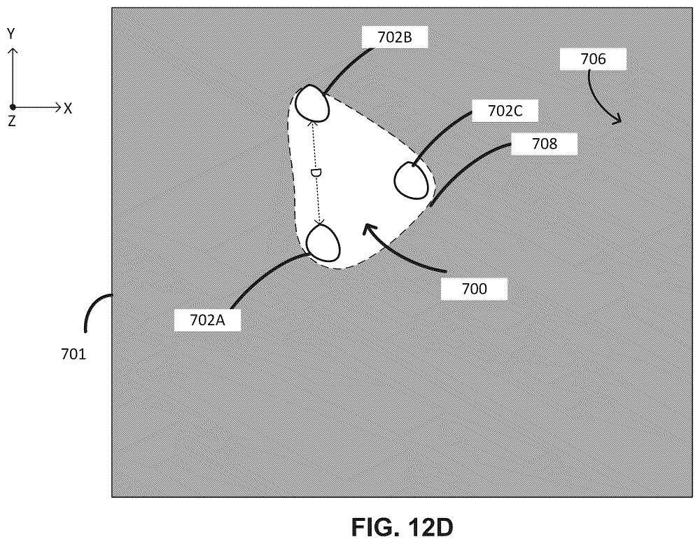

FIGS. 12A, 12B, 12C, and 12D are schematic illustrations of various representations of example particle 700. FIG. 12A illustrates a frame 701 where an imager (e.g., imager 110, FIG. 1) captured particle 700 from a side view against background 706. Particle 700 may be irradiated by a beam (116, FIG. 1) from light source 114 (FIG. 1). FIGS. 12B, 12C, and 12D illustrate frames where an imager such as imager 110 of FIG. 1 captured example particle 700 from a top view, such as a frame at a different time (e.g., a second time) where suspended particle 700 has rotated relative to imager 700 within a stream of gas. As illustrated in FIG. 12A, particle contours 702A, 702B, 702C, 702D define various portions of particle 700.

FIG. 12B illustrates image data before particle contour broadener 224 (FIG. 7) broadens particle contours 702A, 702B 702C, while FIG. 12C illustrates broadened particle contours 704A, 704B, 704C, 704D. Particle contours 702A, 702B, and 702C define islands or spots in FIG. 12B, because imager 110 may only capture and record the top of the spikes of particle 700 due to the topography of irregularly shaped particle 700, the zoom of imager 700, or both. As illustrated, absent particle contour broadening, the islands defined by particle contours 702A, 702B, 702C may be counted as three small individual particles, resulting in overcounting and undersizing particle 700. After application of contour broadening in FIG. 12C, broadened particle contours are stretched relative to their original size to generate broadened particle contours 704A, 704B, and 704C as discussed above. Processing circuitry 204 (FIG. 7) may determine that broadened particle contours 704A, 704B, and 704C intersect at points 710A, 710B, and 710C. Responsive to determining that the broadened particle contours intersect, processing circuitry 204 (FIG. 7) may be configured to determine that boundary 708 should be determined such that particle 700 includes all three particle contours 702A, 702B, 702C.

In some examples, as illustrated in FIG. 12C, particle boundary 708 may be based on broadened particle contours 704A, 704B, and 704C, and in some examples boundary 708 may surround the broadened particle contours. Alternatively, as best illustrated in FIG. 12D, particle boundary 708 may surround non-broadened particle contours 702A, 702B, and 702C. In some examples, boundary 708 may define straight lines connecting particle contours, or may be defined by a fitting function as described above.

With continued reference to FIG. 12D, in some examples, determining a boundary based on broadened particle contours, processing circuitry 204 may simply be configured to measure the distance D between defined particle contours 702A and 702B, and determining that distance D is less than a threshold distance between particles. Particle boundary 708 may be determined to surround both particle contours based on this determination. Thus, as demonstrated in FIGS. 12A-12D, the disclosed systems and techniques may more accurately count and size particle 700 than other particle detection and analysis techniques.

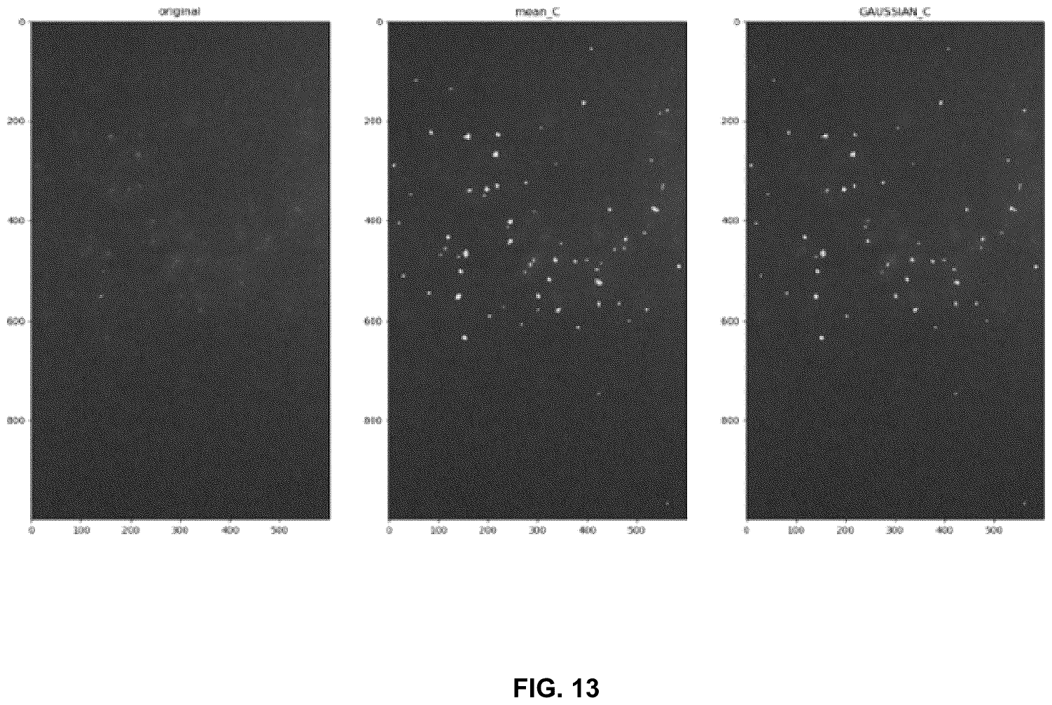

FIG. 13 is a set of pictures illustrating the results of particle detection and image processing techniques in accordance with one or more aspects of the present disclosure. Several methods, such as the adaptive mean threshold and the adaptive Gaussian threshold, have been tested to determine the particle contours. FIG. 13 illustrates the original picture from a particle detection video (left) and the pictures after the particle recognition with marks for the identified particle (middle and right).

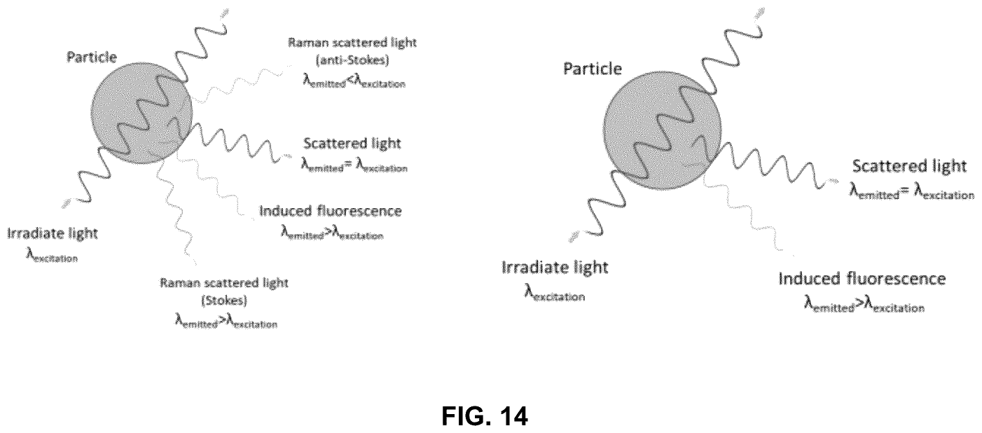

FIG. 14 are schematic conceptual views illustrating example reactions from a particle under irradiation by a light source. Referring to the picture on the left, irradiation of the particle by, for example, light source 114 (FIG. 1) may occur at an excitation wavelength. When light rays in beam 116 (FIG. 1) contact a particle, several rays may result, including Raman (Stokes) scattered light, which may be at a wavelength less than the wavelength of excitation, induced fluorescence, which also may be at a wavelength less than the wavelength of excitation. Irradiation may further result in scattered light, which may be equal to the wavelength of excitation, and Raman (anti-Stokes) scattered light, which may be at a wavelength greater than the wavelength of excitation. On the right, the types of light which may be utilized in some examples of the current disclosure, for example scattered light and induced fluorescence. In some examples, the Raman scattered light may be filtered before reaching imager 110.

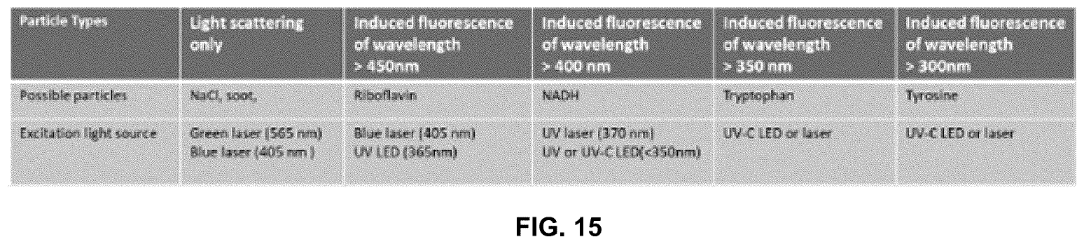

FIG. 15 is a table illustrating example particle information which may be stored in a memory in accordance with one or more aspects of the present disclosure. The disclosed systems and techniques may be used to distinguish biological and non-biological particles based on the difference between elastic light scattering and induced fluorescence from particles when the particles are irradiated with an excited light source. A wavelength of included fluorescence gives a unique signature of the biological particle. FIG. 14 shows the detection mechanisms and FIG. 15 shows the known wavelengths of induced fluorescence of several biological particles, which may be stored in memory 202 (FIG. 7) and matched to one or more sensed particles in detection chamber 102 (FIG. 1).

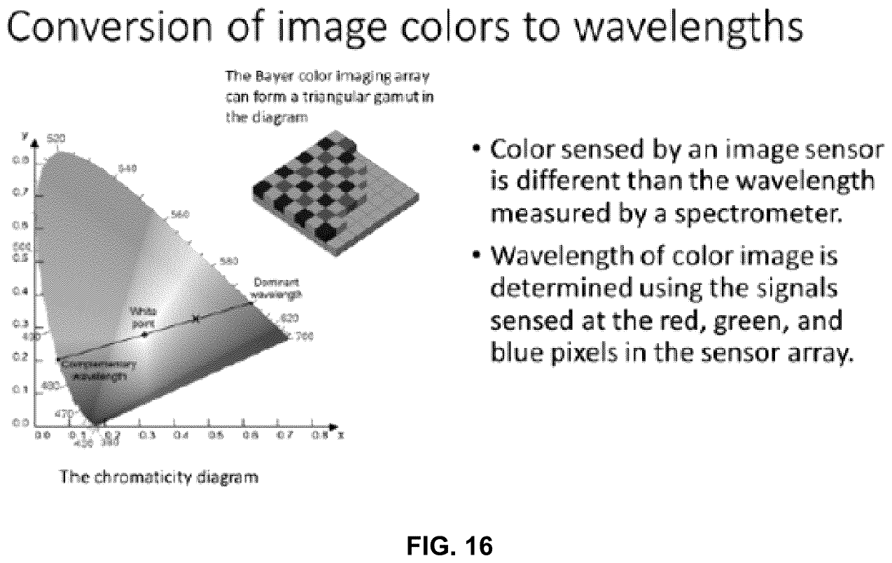

FIG. 16 illustrates an example chromaticity diagram for determining a color hue used to calculate a dominant wavelength in accordance with one or more aspects of the present disclosure. The conversion of the color to the wavelength of induced fluorescence in systems and techniques may be based on the concept of dominant wavelength in the color chromaticity diagram. The hue of the color image of a particle, derived from the signals from red, green, and blue sensing pixels, is the major parameter used for converting the color to the wavelength. The effect of saturation and brightness on the conversion is considered. In some examples, the calculated wavelength calculated by processing circuitry 204 may be adjusted or calibrated, using particles with known emitted wavelength. In some examples, more than calibrating wavelength may be used.

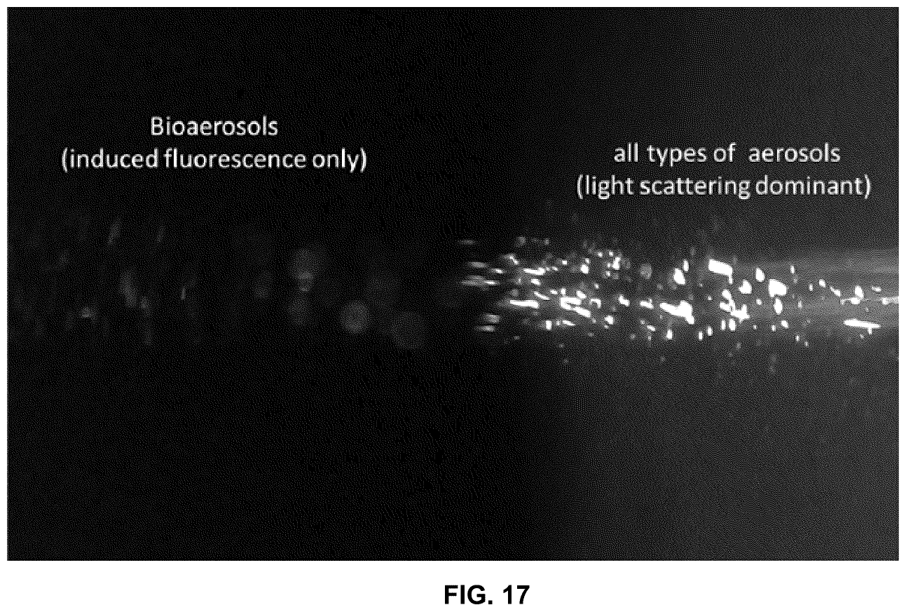

FIG. 17 illustrates an example color image in accordance with one or more aspects of the present disclosure. As illustrated in some examples imager 110 may be a single imager that is configured to capture both induced fluorescence and light scattering image data within the same frame. For example, a portion of the frame of imager 110 may be filtered, such that the sensed and captured image data matrix captures different types of light. In this way, light scattered or emitted by certain types of particles may be distinguished from light scattered or emitted by other types of particles. In this way, bioparticles may be sensed by systems and techniques of the present disclosure. In some examples, induced fluorescence from bioaerosols may be captured without noise from other particles.

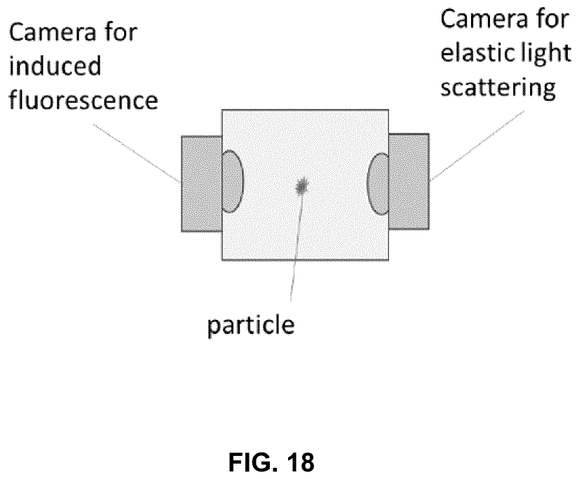

FIG. 18 is a schematic diagram illustrating a portion of an example system in accordance with one or more aspects of the present disclosure. In some examples imager 110 of FIG. 1 may include more than one image sensor or camera. In some examples, one camera, which may be a color video camera, may be configured to capture image data corresponding to induced fluorescence image data, and the second camera, which may also be a color video camera, may be configured to capture image data corresponding to clastic light scattering image data.

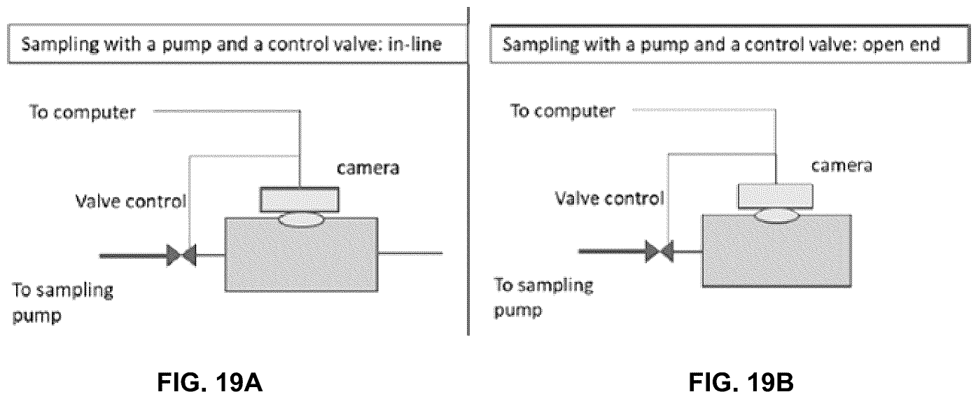

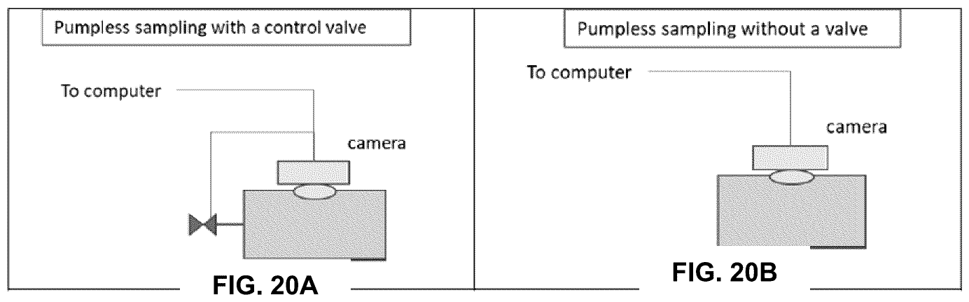

FIGS. 19A and 19B illustrate example systems for sampling in accordance with one or more aspects of the present disclosure. Systems and techniques according to the present disclosure may provide the advantage that particles need not be forced to flow through a small optical focus point. Therefore, more options to sample a gas stream may be available to sample the particles. Furthermore, since processing circuitry 204 (FIG. 7) may be configured to facilitate the capture and storage of sampling data in memory 202 (FIG. 7), all of these sampling options may be supported by system 100. For example, sampling may include a pump, and processing circuitry 204 may control a control valve for continuous sampling or pulse sampling. In some examples, example systems may not include a pump, and may be based on the natural motion of particles or the motion of the camera, as illustrated in FIGS. 20A and 20B. In some examples, instruction stored in a memory may provide suggestions on the optimal speed of the pump, control valve, and/or the camera, based on detection and analysis results. As such, a machine learning module may be employed. As illustrated, in some examples, suspended particle detection systems may include a pump and/or one or more blowers (113, FIG. 1) and a control valve.

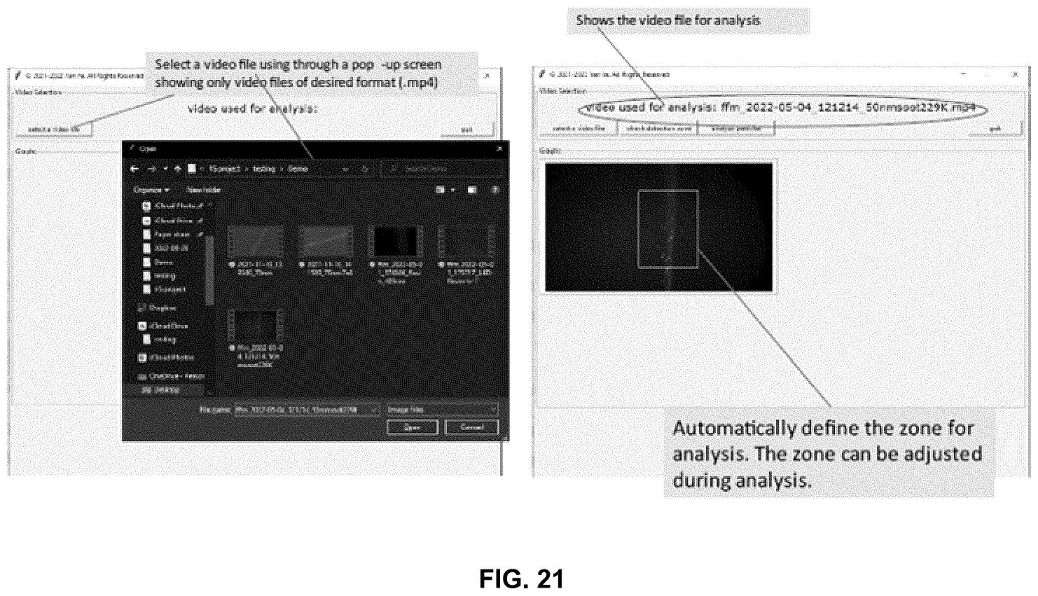

FIG. 21 illustrates example screenshots from a display in accordance with one or more aspects of the present disclosure. The illustrated example illustrates how a GUI such a GUI 130 of FIG. 1 may facilitate easy interaction the disclosed systems to perform the disclosed techniques.

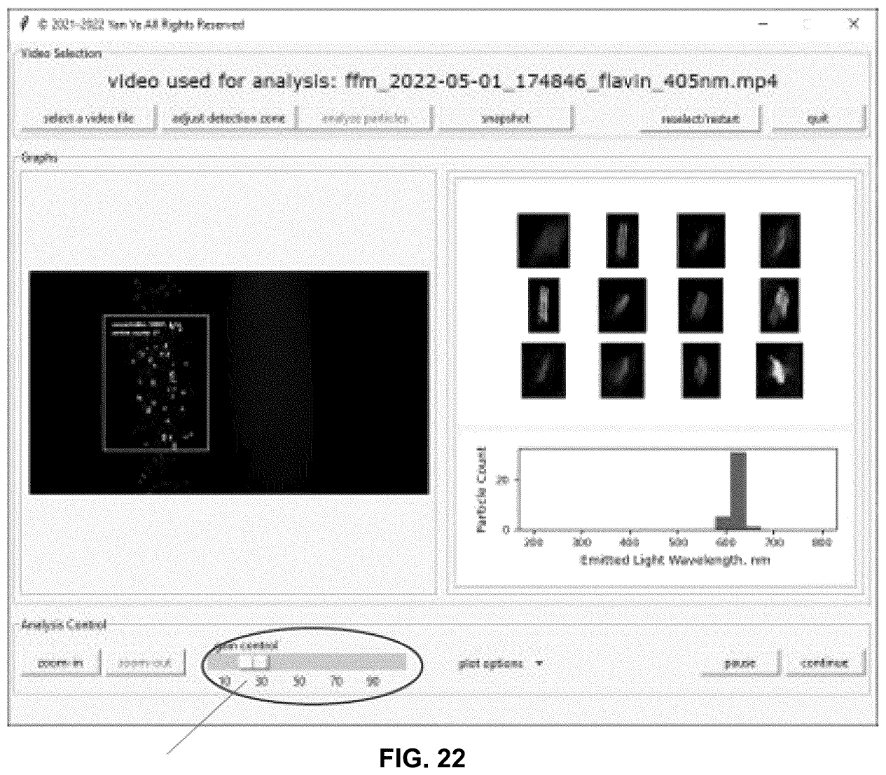

FIG. 22 illustrates an example screenshot from a display according to the present disclosure. As illustrated, particular particle images may be generated and presented, along with a particle count over time. As circled, the user interface may present a knob to adjust particle detection effectiveness, for example by adjusting a gain control to increase particle image recognition. Also as discussed above, the settings may be placed in manual or auto mode. As described above, an adaptive Gaussian threshold may be used to distinguish between light scattering particles and background.

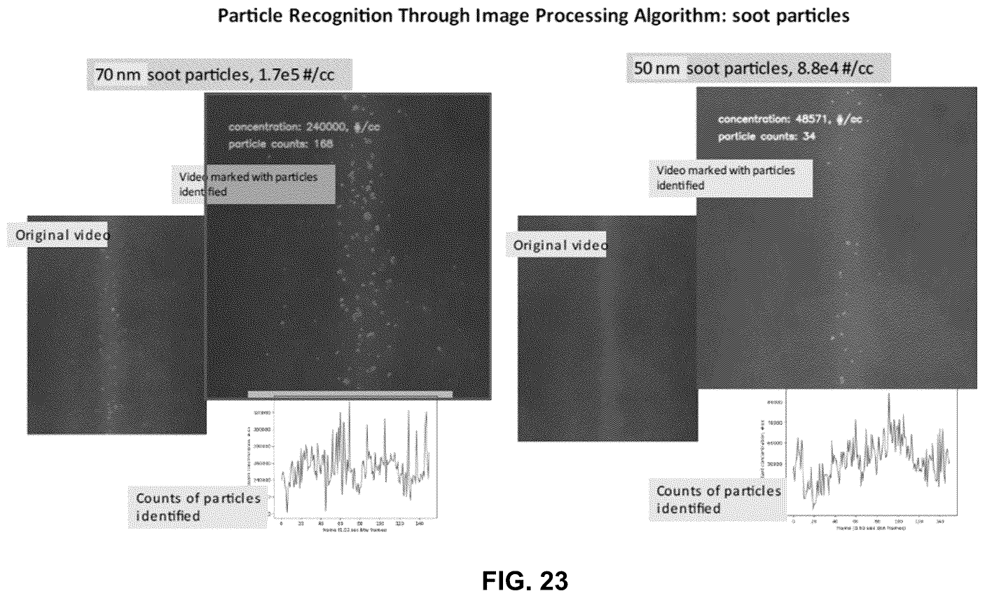

FIG. 23 illustrates example results from particle recognition tests on soot particles through the disclosed image processing techniques and systems. As illustrated on the left, the disclosure provides for detection and analysis of particles less than or equal to 70 nm in size, where the soot particles are not visible in the original video. Even further, the disclosure provides for detection and analysis of particles less than 50 nm in size, where the soot particles are not visible in the original video.

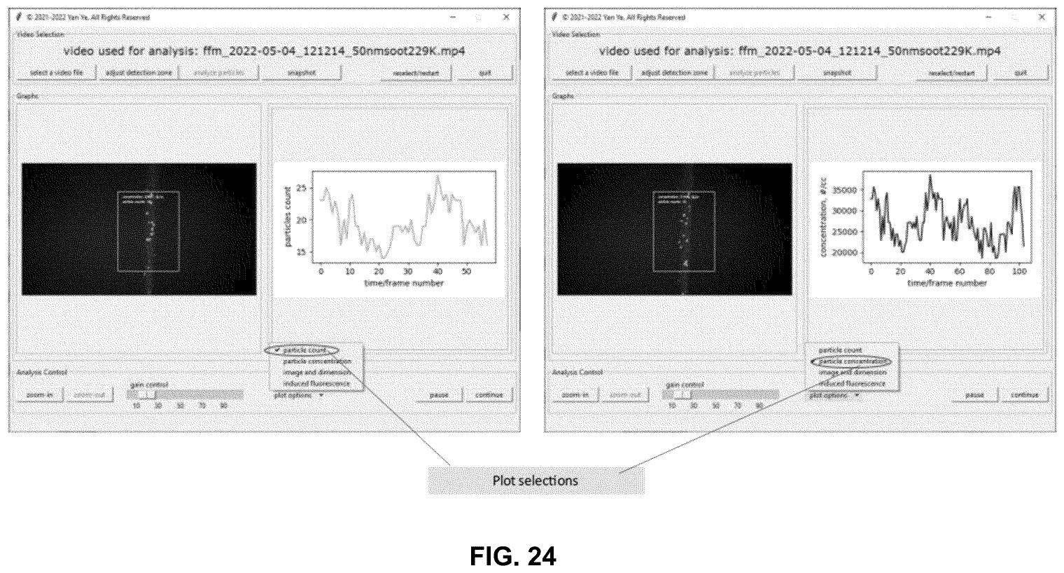

FIG. 24 illustrates example screenshots from an example display according to the present disclosure. As illustrated, one or more of the qualitative or quantitative information regarding at least one particle may be selected for display by a user.

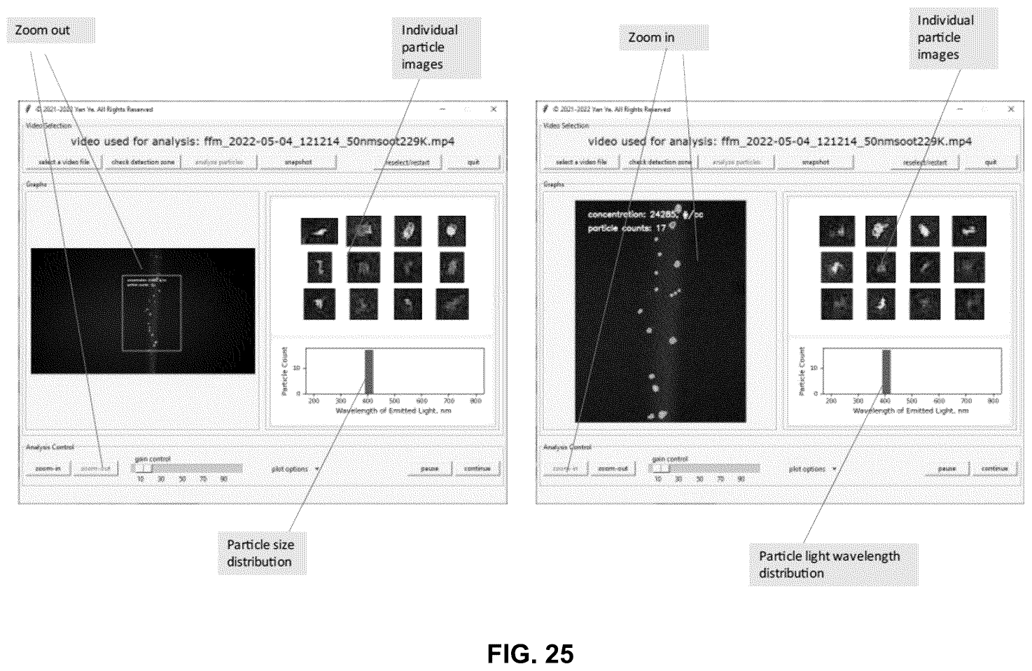

FIG. 25 illustrates example screenshots from an example display according to the present disclosure. Additional features and functionality are illustrated to demonstrate the qualitative and quantitative information the disclosed systems and techniques are capable of generating.

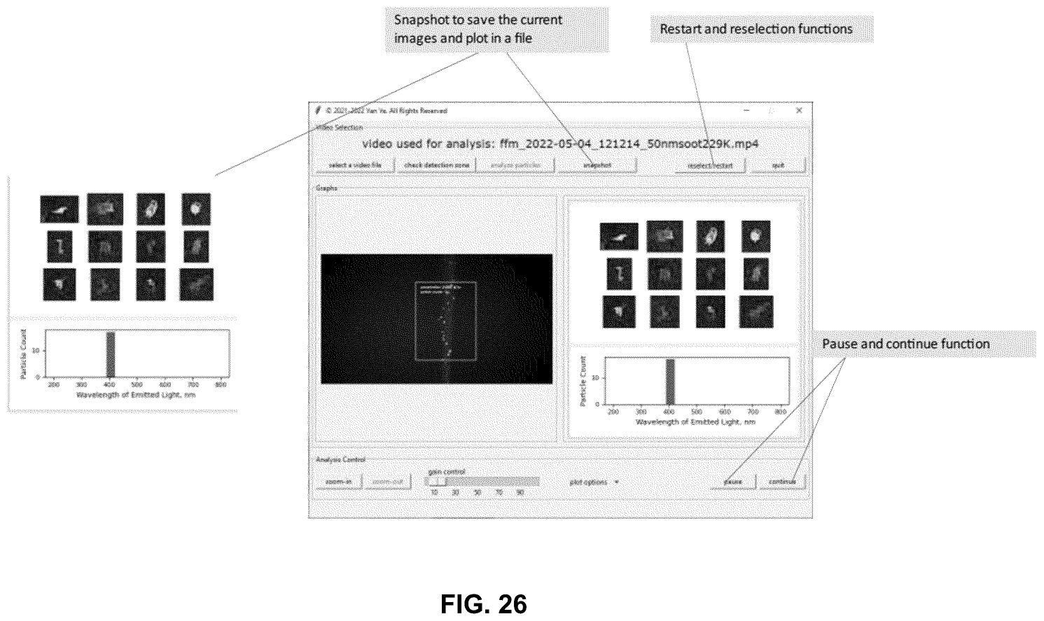

FIG. 26 illustrates example screenshots from an example display according to the present disclosure demonstrating additional features and functionality are illustrated to further demonstrate systems and techniques according to the present disclosure.

One or more of the techniques described in this disclosure may be implemented, at least in part, in hardware, software, firmware or any combination thereof. For example, various aspects of the described techniques may be implemented within one or more processors or processing circuitry, including one or more microprocessors, digital signal processors (DSPs), application specific integrated circuits (ASICs), field programmable gate arrays (FPGAs), graphics processing units (GPUs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, circuits or components may be implemented together or separately as discrete but interoperable logic devices. Depiction of different features as circuits or units is intended to highlight different functional aspects and does not necessarily imply that such circuits or units must be realized by separate hardware or software components. Rather, functionality associated with one or more circuits or units may be performed by separate hardware or software components or integrated within common or separate hardware or software components.

Various examples have been described. These and other examples are within the scope of the following clause and claims.

Clause 1. A method of suspended particle detection, the method comprising: receiving, with a particle concentrator, an aerosol comprising particles suspended within a bulk gas, the aerosol having a first concentration indicative of count of particles per unit volume of the bulk gas; concentrating, with the particle concentrator, the aerosol to generate a particle-rich stream of gas comprising at least one particle, the particle-rich stream of gas having a second concentration greater than the first concentration; irradiating the at least one particle in the particle-rich stream of gas with a light source of a certain wavelength in a detection chamber; and capturing image data relating to the at least one particle with an image sensor located within the detection chamber.

Clause 2. The method of clause 1, further comprising: obtaining a frame of grayscale image data comprising luminance values of image data captured by the image sensor or camera; analyzing the image data in the frame to identify at least one particle captured in the frame, wherein analyzing the image data comprises: identifying pixels having luminance values that satisfy a threshold; and determining particle contours of the at least one particle based on the identified pixels; and generating at least one of quantitative or qualitative information for the at least one particle based at least partially on the analyzing of the image data.

Clause 3. The method of clause 1, wherein concentrating the aerosol comprises: receiving at least a portion of the bulk gas into at least one inlet of the particle concentrator; outputting a particle-lean stream of gas as a major flow stream from a first outlet of the particle concentrator; and outputting the particle rich-stream of gas as a minor flow stream from a second outlet of the particle concentrator.

Clause 4. The method of clause 3, wherein a ratio of a volumetric flow rate of the particle-lean stream of gas to a volumetric flow rate of the particle-rich stream of gas is in a range of from about 10:1 to about 1000:1.

Clause 5. The method of clause 3 or clause 4, wherein a concentration ratio between the particle-rich stream of gas and the aerosol is in a range of from about 10 to about 1000.

Clause 6. The method of any of clauses 1-5, wherein concentrating the aerosol further comprises powering a blower, and wherein the blower causes at least a portion of the bulk gas to be received by an inlet of the particle concentrator and causes the particle-rich stream of gas to be available at the output of the particle concentrator.

Clause 7. The method of clause 6, wherein powering the blower comprises providing power to the blower in a range of from about 10 watts to about 300 watts.

Clause 8. The method of any of clauses 1-7, wherein the particle concentrator is a concentrating virtual impactor (CVI) device that performs an inertia-based preferential particle separation.

Clause 9. The method of any of clauses 1-8, wherein concentrating the aerosol comprises passing the bulk gas through a nozzle, receiving the minor flow stream at a receiving tube, and ejecting the major flow stream at a major flow exit, wherein the minor flow stream is the particle-rich stream of gas and the major flow stream is the particle-lean stream of gas.

Clause 10. The method of clause 9, wherein the major flow exit substantially surrounds the receiving tube.

Clause 11. The method of clause 9, wherein the major flow exit is disposed at an angle of from about 90 degrees to about 180 degrees from the receiving tube.

Clause 12. The method of clause 9, wherein concentrating the aerosol comprises preferentially separating at least one particle by the particle's inertia into the particle-rich stream of gas.

Clause 13. The method of clause 12, wherein preferentially separating particles comprises: causing a majority of particles in the aerosol which have a maximum dimension that is above a particle size cut point in the aerosol to enter the particle-rich minor stream of gas.

Clause 14. The method of clause 13, wherein the particle size cut point is about 1 (±0.5) micrometer or larger.

Clause 15. The method of any of clauses 1-14, wherein concentrating the aerosol comprises: between sampling the aerosol and outputting the particle-rich stream of gas, concentrating the aerosol in a first stage comprising a first set of nozzles, and further concentrating the aerosol in a second stage comprising a second set of nozzles.

Clause 16. The method of clause 14, wherein each nozzle of the first set of nozzles and each nozzle of the second set of nozzles defines an aperture that is larger than about 1 millimeter.

Clause 17. The method of clause 14 or clause 15, wherein the first set of nozzles comprises more than one nozzle and the second set of nozzles consists of a single nozzle.

Clause 18. The method of any of clauses 1-17, further comprising performing a first-pass preseparator to remove a majority of particles which have a maximum dimension above a second particle size cut point desired for concentration enhancement.

Clause 19. The method of clause 17, wherein the second particle size cut point is about 10 micrometers or larger from an inlet stream of gas.

Clause 20. The method of clause 18 or clause 19, wherein particle preseparator comprises performing an inertia-based separation in the particle concentrator.

Clause 21. The method of any of clauses 1-20, wherein the particle concentrator is formed by an additive manufacturing process.

Clause 22. The method of any of clauses 1-21, wherein the particle concentrator has a maximum dimension of less than about 150 millimeters.

Clause 23. The method of clause 2, wherein the light source is an external light source, wherein the light source comprises a laser or LED, and wherein the light source generates a beam of light with a wavelength below 450 nanometers (nm), such as from about 250 nm to about 350 nm.

Clause 24. The method of clause 2, wherein the captured image data comprises image data of at least one particle induced or enhanced by the light source.

Clause 25. The method of clause 2, wherein the image sensor or camera comprises a color image sensor or camera, such as a color video camera.

Clause 26. The method of clause 2, wherein the image data includes a red image data matrix, a green image data matrix, and a blue image data matrix, and wherein obtaining grayscale image data comprises at least one of summing or averaging each of the red image data matrix, the green image data matrix, and the blue image data matrix to form an overall image data matrix.

Clause 27. The method of clause 2, wherein identifying pixels having luminance values that satisfy the threshold comprises: determining local thresholds within respective subsets of pixels; comparing luminance values of pixels within each respective subsets of pixels to respective local threshold for that subset of pixels; and sweeping through the subsets to pixels to identify the pixels based on the comparison, and wherein determining particle contours comprises grouping the identified pixels of each of the respective subsets of pixels together as an island of particle contours.

Clause 28. The method of clause 27, wherein determining the local thresholds comprises averaging pixel values of the image data within the respective subsets of pixels.

Clause 29. The method of clause 28, further comprising identifying adjacent islands of particle contours as belonging to the same particle, wherein determining the particle contours comprises determining particle contours by fitting the data in the subsets of pixels using a fitting function.

Clause 30. The method of clause 29, wherein the fitting function is a Gaussian function.

Clause 31. The method of clause 2, wherein identifying pixels having luminance values that satisfy the threshold comprises: determining the threshold within the image data; comparing luminance values of pixels to the threshold; and
identifying the pixels based on the comparison, and wherein determining particle contours comprises grouping the identified pixels together as an island of particle contours.

Clause 32. The method of clause 31, wherein determining the local thresholds comprises averaging pixel values of the image data within the respective subsets of pixels.

Clause 33. The method of clause 2, further comprising: applying a gain adjustment to the luminance values to determine adjusted luminance values for one or more pixels, wherein identifying pixels that satisfy the threshold comprises identifying pixels that satisfy the threshold based on the adjusted luminance values.

Clause 34. The method of clause 2, wherein the identified pixels comprises a first pixel and a second pixel that are separated by a distance, wherein determining particle contours comprises: assigning one or more pixels, within the distance, proximate to the first pixel and second pixel approximately the same luminance value as nearest pixel within identified pixels to create a broadened cluster of pixels that include the first pixel and the second pixel; and determining the particle contours based on the cluster of pixels.

Clause 35. The method of any of clauses 1-34, wherein generating at least one of quantitative or qualitative information includes generating quantitative information comprising at least one of a particle count or a particle concentration.

Clause 36. The method of any of clauses 1-35, wherein generating at least one of quantitative or qualitative information includes generating qualitative information comprising images of individual particles, sizes of the captured particles represented by the image data, and colors or dominant wavelengths of induced or enhanced light emitting from the captured particles.

Clause 37. The method of any of clauses 1-36, further comprising: selecting a file from a memory associated with the image sensor or color image data directly camera; and reading a frame from the file to generate the grayscale image data.

Clause 38. The method of clause 37, wherein the file comprises video data.

Clause 39. The method of clause 37, further comprising determining whether the file contains at least one additional frame, and responsive to determining that the file contains at least one additional frame, reading a second frame from the file to generate a second set of grayscale image data.

Clause 40. The method of any of clauses 38 or 39, wherein generating at least one of quantitative or qualitative information for the at least one particle based at least partially on the determined particle contours comprises marking the at least one particle within the image data based on the determined boundary.

Clause 41. The method of clause 40, further comprising counting the marked at least one particle.

Clause 42. The method of clause 41, further comprising determining a particle concentration based on the counted at least one particle.

Clause 43. The method of any of clauses 40-42, further comprising determining the size of at least one particle within the frame based on the determined boundary.

Clause 44. The method of clause 2, further comprising: receiving color image data that includes colors in addition to black and white, wherein the color image data is from the image sensor or camera, and wherein the grayscale image data is based on the color image data; performing color analysis on the color image data using the determined particle contours, wherein generating at least one of the quantitative or qualitative information comprises generating qualitative information based on the color analysis.

Clause 45. The method of clause 44, wherein performing color analysis comprises locating a particle area in the color image data.

Clause 46. The method of clause 45, wherein performing color analysis comprises determining a dominant color within the particle area.

Clause 47. The method of any of clauses 44-46, wherein performing color analysis comprises converting the dominant color to a dominant wavelength of the at least one particle by using the hue of the color image data to calculate the wavelength of induced fluorescent light emitted by the at least one particle.

Clause 48. The method of clause 47, wherein converting the dominant color to a dominant wavelength of at least one particle is based at least partially on signals sensed at red, green, and blue pixels in a sensor array of the image sensor.

Clause 49. The method of clause 48, further comprising comparing the dominant wavelength of at least one particle to a database of known wavelengths to determine a particle species.

Clause 50. The method of clauses 48 or 49, further comprising comparing the dominant wavelength of the at least one particle to a database of known wavelengths to determine a particle type, wherein the particle type is a bioaerosol or an abiotic aerosol.

Clause 51. The method of any of clauses 1-50, further comprising outputting, for display via a display, a representation of one or more pieces of the at least one of quantitative or qualitative information, wherein the at least one of quantitative or qualitative information comprises one or more of a particle count, a particle size, a particle concentration, a particle type, or a particle species.

Clause 52. A system configured to perform the method of any of clauses 1-51.

Clause 53. A system comprising: a particle concentrator; and a particle detection and analysis unit comprising: at least one light source of a certain wavelength configured to irradiate at least one particle; at least one image sensor or camera configured to capture image relating to the at least one particle; and one or more processors configured to: obtain a frame of grayscale image data comprising luminance values of image data captured by the image sensor or camera; analyze the image data in the frame to identify at least one particle captured in the frame, wherein to analyze the image data, the one or more processors are configured to: identify pixels having luminance values that satisfy a threshold; and determine particle contours of the at least one particle based on the identified pixels; and generate at least one of quantitative or qualitative information for the at least one particle based at least partially on the analyzing of the image data.

Clause 54. The system of clause 53, further comprising performing the method of any of claims 1-50.

Clause 55. A system comprising: a particle concentrator configured to receive an aerosol having a first concentration of particles and output a particle-rich stream of gas having a second concentration of particles to a particle sensor; and a particle sensor comprising: a light source configured to irradiate at least one particle in the particle-rich stream of gas; an image sensor to capture an image of the at least one particle; and processing circuitry configured to perform and image analysis algorithm to analyze the image of the at least one particle.

1. A method of suspended particle detection, the method comprising:
receiving, with a particle concentrator, an aerosol comprising particles suspended within a bulk gas, the aerosol having a first concentration indicative of count of particles per unit volume of the bulk gas;
concentrating, with the particle concentrator, the aerosol to generate a particle-rich stream of gas comprising at least one particle, the particle-rich stream of gas having a second concentration greater than the first concentration;
irradiating the at least one particle in the particle-rich stream of gas with a light source of a certain wavelength in a detection chamber; and
capturing image data relating to the at least one particle with an image sensor located within the detection chamber.

2. The method of claim 1, further comprising:
obtaining a frame of grayscale image data comprising luminance values of image data captured by the image sensor or camera;
analyzing the image data in the frame to identify at least one particle captured in the frame, wherein analyzing the image data comprises:
identifying pixels having luminance values that satisfy a threshold; and
determining particle contours of the at least one particle based on the identified pixels; and
generating at least one of quantitative or qualitative information for the at least one particle based at least partially on the analyzing of the image data.

3. The method of claim 1, wherein concentrating the aerosol comprises:
receiving at least a portion of the bulk gas into at least one inlet of the particle concentrator;
outputting a particle-lean stream of gas as a major flow stream from a first outlet of the particle concentrator; and
outputting the particle rich-stream of gas as a minor flow stream from a second outlet of the particle concentrator.

4. The method of claim 3, wherein a ratio of a volumetric flow rate of the particle-lean stream of gas to a volumetric flow rate of the particle-rich stream of gas is in a range of from about 10:1 to about 1000:1.

5. The method of claim 1, wherein concentrating the aerosol further comprises powering a blower, and wherein the blower causes at least a portion of the bulk gas to be received by an inlet of the particle concentrator and causes the particle-rich stream of gas to be available at the output of the particle concentrator.

6. The method of claim 5, wherein powering the blower comprises providing power to the blower in a range of from about 10 watts to about 300 watts.

7. The method of claim 1, wherein the particle concentrator is a concentrating virtual impactor (CVI) device that performs an inertia-based preferential particle separation.

8. The method of claim 7, wherein preferentially separating particles comprises:
causing a majority of particles in the aerosol which have a maximum dimension that is above a particle size cut point in the aerosol to enter the particle-rich minor stream of gas.

9. The method of claim 8, wherein the particle size cut point is about 1 (±0.5) micrometer or larger.

10. The method of claim 1, wherein concentrating the aerosol comprises passing the bulk gas through a nozzle, receiving the minor flow stream at a receiving tube, and ejecting the major flow stream at a major flow exit, wherein the minor flow stream is the particle-rich stream of gas and the major flow stream is the particle-lean stream of gas.

11. The method of claim 10, wherein the major flow exit substantially surrounds the receiving tube.

12. The method of claim 1, wherein concentrating the aerosol comprises:
between sampling the aerosol and outputting the particle-rich stream of gas, concentrating the aerosol in a first stage comprising a first set of nozzles, and concentrating the aerosol in a second stage comprising a second set of nozzles.

13. The method of claim 1, further comprising performing a first-pass preseparator to remove a majority of particles which have a maximum dimension above a second particle size cut point desired for concentration enhancement.

14. The method of claim 13, wherein the second particle size cut point is about 10 micrometers or larger from an inlet stream of gas.

15. The method of claim 13, wherein performing the first-pass preseparator comprises performing an inertia-based separation in the particle concentrator.

16. The method of claim 1, wherein the particle concentrator is formed by an additive manufacturing process.

17. The method of claim 1, wherein the particle concentrator has a maximum dimension of less than about 150 millimeters.

18. A system comprising:
a particle concentrator; and
a particle detection and analysis unit comprising:
at least one light source of a certain wavelength configured to irradiate at least one particle;
at least one image sensor or camera configured to capture image relating to the at least one particle; and
one or more processors configured to:
obtain a frame of grayscale image data comprising luminance values of image data captured by the image sensor or camera;
analyze the image data in the frame to identify at least one particle captured in the frame, wherein to analyze the image data, the one or more processors are configured to:
identify pixels having luminance values that satisfy a threshold; and
determine particle contours of the at least one particle based on the identified pixels; and
generate at least one of quantitative or qualitative information for the at least one particle based at least partially on the analyzing of the image data.

19. The system of claim 18, wherein the particle concentrator is integral with the particle detection and analysis unit.

20. A system comprising:
a particle concentrator configured to receive an aerosol having a first concentration of particles and output a particle-rich stream of gas having a second concentration of particles to a particle sensor; and
a particle sensor comprising:
a light source configured to irradiate at least one particle in the particle-rich stream of gas;
an image sensor to capture an image of the at least one particle; and
processing circuitry configured to perform and image analysis algorithm to analyze the image of the at least one particle.
